(19) United States
(12) Patent Application Publication
(10) Pub. No.: US 2008/0099447 A1
(43) Pub. Date: May 1, 2008

(54) Plasma processing apparatus and plasma processing method

(76) Inventors: Makoto Ando, Tokyo (JP); Takuichi Hirano, Tokyo (JP); Yukihiko Nakata, Beppu-shi (JP); Kazufumi Azuma, Yokohama-shi (JP); Masashi Goto, Ibaraki-shi (JP); Atsushi Sasaki, Yokohama-shi (JP); Tetsuya Ide, Yokohama-shi (JP); Tetsuya Okamoto, Nara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/544,051

(22) Filed: Oct. 6, 2006

(51) Int. Cl. B23K 9/00

(52) U.S. Cl. 219/121.43

(57) ABSTRACT

A plurality of electromagnetic wave radiation waveguides are formed to branch from an electromagnetic wave distribution waveguide. A plurality of slots are provided to each electromagnetic wave radiation waveguide. A width of the electromagnetic wave radiation waveguide, a height of the electromagnetic wave radiation waveguide and an electromagnetic wave radiation waveguide cycle p are set to satisfy a relationship of λ₀>p>a₂>b₂ and p=(λ_{g1}/2)+±α (where α is 5% or below of λ_{g1}), where λ₀ is a free space wavelength of an electromagnetic wave, al is a width of the electromagnetic wave distribution waveguide, εᵣ₁ is a specific inductive capacity of a dielectric material in the electromagnetic wave distribution waveguide, and λ_{g1} is a wavelength of the electromagnetic wave output from the electromagnetic wave source in the electromagnetic wave distribution waveguide.

### BACKGROUND OF THE INVENTION

1. Field of the Invention

The present invention relates to a plasma processing apparatus and a plasma processing method applied to a manufacturing process of a semiconductor element such as a thin film transistor (a TFT) or a metal oxide semiconductor element (an MOS element), a semiconductor device such as a semiconductor integrated circuit device, or a display device such as a liquid crystal display device.

2. Description of the Related Art

Generally, in a manufacturing process of a semiconductor device, a liquid crystal display device or the like, a parallel-plate type high-frequency plasma processing apparatus, an electron cyclotron resonance (ECR) plasma processing apparatus or the like is used as an apparatus which performs plasma processing such as film deposition, surface modification or etching.

However, the parallel-plate type plasma resonance apparatus has a problem of a low plasma density and a high electron temperature. Further, the ECR plasma processing apparatus requires a direct-current magnetic field for plasma excitation, and hence it has a problem of a difficulty in processing of a substrate having a large area.

For such problems, there has been recently proposed a plasma processing apparatus which does not require a magnetic field for plasma excitation and is capable of generating plasma having a high density and a low electron temperature.

As this type of plasma processing apparatus, there is known one which is provided with a circular flat antenna having a plurality of concentrically or spirally formed slots. In this plasma processing apparatus, a microwave generated in a microwave generator propagates through a coaxial waveguide to reach a flat antenna member. While the microwave radially propagates to a peripheral portion from a central part of this flat antenna member, an electrostatic field is generated between the slits. As a result, an electric field is formed immediately below the flat antenna member, i.e., in an upper portion of a processing space, and hence an etching gas is excited by this electrostatic filed to turn to plasma (see, e. g., Jpn. Pat. Appln. KOKAI Publication No. 1997-063793).

Furthermore, as the plasma processing apparatus, there has been known one having a configuration in which a microwave is supplied into a chamber through a dielectric window from two slots forming a waveguide antenna arranged on an H surface of a rectangular waveguide. In this plasma processing apparatus, a width of each slot is narrowed as getting closer to a reflection surface. Moreover, each slot is formed into a step-like shape or a tapered shape so that it become narrower toward the reflection surface of the waveguide (see, e.g., Japanese Patent No. 2857090).

Additionally, as the plasma processing apparatus, there has been known one in which a plurality of rectangular waveguides are arranged in parallel at equal intervals. Coupling holes having coupling coefficients sequentially increased toward an end side are provided to each waveguide. Pluralities of dielectric windows individually formed in accordance with the respective coupling holes are provided to a vacuum chamber (see, e.g., Jpn. Pat. Appln. KOKAI Publication No. 2002-280196).

Further, as the plasma processing apparatus, there has been known one having a configuration in which a microwave is led into a tabular dielectric cableway through a microwave waveguide. The dielectric cable way has an introducing portion inserted into the microwave waveguide, a rectangular portion, and a matching portion which couples the introducing portion with the rectangular portion. In this plasma processing apparatus, the microwave is introduced from the matching portion, transmitted through a waveguide corresponding portion formed of a partition wall and the rectangular portion and led into a reaction chamber from a microwave feed port (see, e.g., Jpn. Pat. Appln. KOKAI Publication No. 45799-1999).

Furthermore, as the plasma processing apparatus, there has been known one having a configuration in which a microwave supplied from a microwave oscillator is distributed to a plurality of dielectric lines through a microwave distributor having a plurality of branching paths. The dielectric line is formed of a plurality of rectangular plates extending from an end of the branching path, and the plurality of rectangular plates are partitioned by a conductor plate (see, e.g., Jpn. Pat. Appln. KOKAI Publication No. 11149-1999).

It is to be noted that the present inventors have proposed a plasma processing apparatus in which a plurality of electromagnetic wave radiation waveguides are aligned and arranged in parallel in such a manner that they branch in a vertical direction from an electric field surface or a magnetic field surface of an electromagnetic wave distribution waveguide which is coupled with an electromagnetic wave source (see, The 49th Japan Society of Applied Physics Annual Meeting, Abstract Format of Meeting p. 128 (March, 2002), and ESCAMPIG16 & ICRP5, Abstract Format p. 321 (Jul. 14 to 18, 2002)).

However, when a microwave is propagated through a conductor such as a coaxial waveguide or a flat antenna member like the plasma processing apparatus described in Jpn. Pat. Appln. KOKAI Publication No. 063793-1997, a propagation loss such as a copper loss is generated in such a conductor. This propagation loss is increased as a frequency becomes higher and a coaxial transmission distance or as an area of the flat antenna member is increased. Therefore, even if a plasma processing apparatus corresponding to a relatively large substrate in, e.g., a liquid crystal display device or the like is designed by utilizing a technology described in Jpn. Pat. Appln. KOKAI Publication No. 063793-1997, an attenuation of the microwave is large, and efficient generation of plasma is difficult. Furthermore, since the plasma processing apparatus described in Jpn. Pat. Appln. KOKAI Publication No. 063793-1997 has a configuration in which a microwave is emitted from the circular flat antenna member, there is a problem that plasma becomes uneven at corner portions of a substrate when this plasma processing apparatus is applied to a rectangular substrate in, e.g., a liquid crystal display device.

Moreover, when a microwave propagated through a rectangular waveguide is radiated from two slots like the plasma processing apparatus described in Japanese Patent No. 2857090, there is a problem that an ambipolar diffusion coefficient of plasma is reduced if many negative ions exist in the generated plasma. Therefore, in the technology described in Jpn. Pat. Appln. KOKAI Publication No. 063793-1997, generation of plasma is biased toward the vicinity of the slots from which the microwave is radiated. Additionally, this bias of plasma becomes more prominent when a pressure of the plasma is high. Therefore, in the plasma processing apparatus described in Jpn. Pat. Appln. KOKAI Publication No. 063793-1997, it is difficult to perform plasma processing using as a raw material a gas containing oxygen, hydrogen, chlorine and others from which negative ions are apt to be generated with respect to a large substrate, and it will become more difficult when a pressure of the gas is high in particular. Further, since a distribution of the slots constituting a waveguide antenna locally exists (is not uniform) on a processing surface of the substrate to which plasma processing is applied, a plasma density tends to become uneven.

Furthermore, there is no description about a method of introducing a microwave into a plurality of waveguides in relation to the technology disclosed in Jpn. Pat. Appln. KOKAI Publication No. 2002-280196. Therefore, it is considered that one microwave power supply must be prepared with respect to one waveguide in order to introduce a microwave into the plurality of waveguides. Therefore, according to the technology described in Jpn. Pat. Appln. KOKAI Publication No. 2002-280196, the apparatus is apt to become complicated. In particular, in case of designing a large plasma processing apparatus corresponding to a large substrate by using the technology described in Jpn. Pat. Appln. KOKAI Publication No. 2002-280196, not only many microwave power supplies are required, but also these microwave power supplies must be simultaneously operated.

Moreover, according to the technology described in Jpn. Pat. Appln. KOKAI Publication No. 2002-280196, since the waveguides are arranged at intervals considering diffusion of plasma, it is difficult to uniformly distribute the coupling holes to correspond to the entire processing target surface of the processing target substrate. Additionally, since seals for vacuum sealing must be provided for the same number as the coupling holes, a configuration of the vacuum chamber tends to become complicated. Further, since a processing cost of a top panel of the vacuum chamber is increased, there is also a problem that a price of the apparatus is apt to become high.

According to the technology described in Jpn. Pat. Appln. KOKAI Publication No. 45799-1999, since a microwave supply direction is parallel with a longitudinal direction of each waveguide corresponding part, it is difficult to distribute a microwave in the introducing portion in such a manner that the microwave becomes uniform with respect to the plurality of waveguide corresponding portions, and it is hard to cope with a large plasma processing apparatus which corresponds to a large substrate. Furthermore, since the introducing portion is provided, there is also a problem that a footprint of the apparatus tends to become large.

According to the technology described in Jpn. Pat. Appln. KOKAI Publication No. 111493-1999, a microwave supplied from the microwave oscillator is distributed to the plurality of dielectric lines through the microwave distributor. In this case, although the microwave distributor and the plurality of dielectric paths exist on the same plane, the microwave distributor tends to become large, and a footprint of the apparatus is thereby apt to become large.

Note) <Our proposal of the prior art and problems>

2. Description of the Related Art

In general, a parallel-plate type radio-frequency plasma processing apparatus, an electron cyclotron resonance (ECR) plasma processing apparatus or the like is used as an apparatus which performs plasma processing in a manufacturing process of a semiconductor device, a liquid crystal display device or the like.

Among others, the parallel-plate type plasma processing apparatus has a drawback of a low plasma density and a high electron temperature. Further, the ECR plasma processing apparatus requires a direct-current magnetic field for plasma excitation, and hence it has a problem of a difficulty in processing of a substrate having a large area.

As an apparatus which compensates these problems, there has been proposed a plasma processing apparatus which is provided with a circular flat antenna member having a plurality of slots and can generate plasma having a high density and a low electron temperature. For example, there is Jpn. Pat. Appln. KOKAI Publication No. 063793-1997, Japanese Patent No. 2857090 or the like. Plasma apparatuses described in these publications have various kinds of problems such as attenuation of a microwave due to a propagation loss of the microwave, nonuniformity of plasma or the like.

### BRIEF SUMMARY OF THE INVENTION

According to a plasma processing apparatus of the present invention, plasma is generated in a processing chamber by using an electromagnetic wave oscillated by an electromagnetic wave source, propagated through an electromagnetic wave distribution waveguide, distributed to a plurality of electromagnetic wave radiation waveguides and radiated into the processing chamber from slots provided to these electromagnetic wave radiation waveguides while being propagated through these electromagnetic wave radiation waveguides, and this plasma is utilized to perform plasma processing to a substrate to be processed.

According to the present invention, there is provided a plasma processing apparatus which performs plasma processing with respect to a substrate to be processed, comprising: an electromagnetic wave source which outputs an electromagnetic wave; an electromagnetic wave distribution waveguide through which the electromagnetic wave output from the electromagnetic wave source is propagated; a plurality of electromagnetic wave radiation waveguides which branch in a vertical direction from an electric field surface or a magnetic field surface of the electromagnetic wave distribution waveguide and are closely aligned and provided in parallel; a plurality of slots which are provided to each of the electromagnetic wave radiation waveguides and constitute a waveguide antenna; and a processing chamber into which the electromagnetic wave radiated from the slots enters,

Wherein, when a guide wavelength λ_{g1} of the electromagnetic wave output from the electromagnetic wave source in the electromagnetic wave distribution waveguide is represented by the following expression:

λ_{g1}=λ₀/{square root over (εᵣ₁−(λ₀/(2a₁))² )}

A width a₂ in the electromagnetic wave radiation waveguide, a height b₂ in the electromagnetic wave radiation waveguide and a cycle p in which the electromagnetic wave radiation waveguides are aligned are set to satisfy the relationship of λ₀>p>a₂>b₂ and p=(λ_{g1}/2)±α (where α is 5% or below of λ_{g1}) where λ₀ is a free space wavelength of the electromagnetic wave output from the electromagnetic wave source, al is a width in the electromagnetic wave distribution waveguide, and εᵣ₁ is a specific inductive capacity of a dielectric material in the electromagnetic wave distribution waveguide, and the plasma is generated by the electromagnetic wave which has entered the processing chamber from the slots.

### BRIEF DESCRIPTION OF THE SEVERAL VIEWS OF THE DRAWING

FIG. 1 is a top view showing a plasma processing apparatus according to a first embodiment of the present invention;

FIG. 2 is a cross-sectional view taken along a line II-II depicted in FIG. 1;

FIG. 3 is an enlarged cross-sectional view showing a region surrounded by an alternate long and short dash line III depicted in FIG. 2;

FIG. 4 is a perspective view showing a region surrounded by an alternate long and short dash line IV depicted in FIG. 2 in a state where an upper wall defining a waveguide is eliminated;

FIG. 5 is a top view showing a plasma processing apparatus according to a second embodiment of the present invention;

FIG. 6 is a cross-sectional view showing a plasma processing apparatus according to a third embodiment of the present invention in a direction orthogonal to electromagnetic wave radiation waveguides;

FIG. 7 is an enlarged cross-sectional view showing a region surrounded by an alternate long and short dash line VII depicted in FIG. 6;

FIG. 8 is a cross-sectional view showing the plasma processing apparatus depicted in FIG. 6 in a direction parallel with the magnetic wave radiation waveguides;

FIG. 9 is an enlarged cross-sectional view showing a region surrounded by an alternate long and short dash line IX depicted in FIG. 8;

FIG. 10 is a view schematically showing a plasma processing apparatus according to a fourth embodiment of the present invention;

FIG. 11 is a view schematically showing a plasma processing apparatus according to a fifth embodiment of the present invention;

FIG. 12 is a top view showing a plasma processing apparatus according to a sixth embodiment of the present invention;

FIG. 13 is a cross-sectional view taken along a line XIII-XIII depicted in FIG. 12;

FIG. 14 is an enlarged cross-sectional view showing a region surrounded by an alternate long and short dash line XIV depicted in FIG. 13;

FIG. 15 is a view schematically showing reverse phase power feeding;

FIG. 16 is a top view showing a plasma processing apparatus according to a seventh embodiment of the present invention;

FIG. 17 is a cross-sectional view taken along a line XVII-XVII depicted in FIG. 16;

FIG. 18 is an enlarged cross-sectional view showing a region surrounded by an alternate long and short dash line XVII depicted in FIG. 17;

FIG. 19 is a cross-sectional view showing an electromagnetic wave distribution waveguide and some of electromagnetic wave radiation waveguides included in the plasma processing apparatus depicted in FIG. 16 along a horizontal direction;

FIG. 20 is an enlarged view of FIG. 19;

FIG. 21 is a bottom view showing some of the electromagnetic wave radiation waveguides included in the plasma processing apparatus depicted in FIG. 16;

FIG. 22 is a view showing distance dependence from dielectric windows of an electron density/an electron temperature in argon plasma generated by using the plasma processing apparatus depicted in FIG. 16;

FIG. 23 is a view showing a film thickness distribution of a plasma oxide film formed from plasma generated from a mixed gas of argon and oxygen by utilizing the plasma processing apparatus depicted in FIG. 16;

FIGS. 24A and 24B are views showing examples of a process flow when forming n channel type and p channel type polycrystal silicon thin film transistors by using the plasma processing apparatus depicted in FIG. 16; and

FIGS. 25A, 25B, 25C, 25D and 25E are element cross-sectional views in each process when forming a polycrystal silicon thin film transistor by using the plasma processing apparatus depicted in FIG. 16.

### DETAILED DESCRIPTION OF THE INVENTION

Embodiments according to the present invention will now be described hereinafter in detailed with reference to the accompanying drawings.

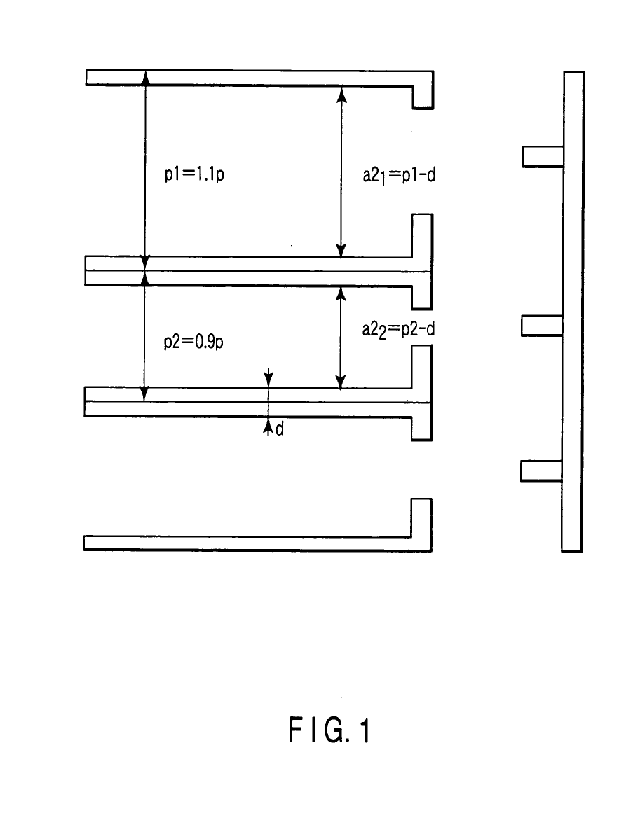

A first embodiment according to the present invention will now be described with reference to FIGS. 1 to 4.

As shown in FIGS. 1 to 4, a plasma processing apparatus 1 according to this embodiment is provided with an electromagnetic wave source 2, an electromagnetic wave distribution waveguide 3, a plurality of, e.g., 10 electromagnetic wave radiation waveguides 4, a slot plate 5, a vacuum chamber 6 as a processing chamber, a plurality of, e.g., 10 electromagnetic wave radiation windows 7, and others. The electromagnetic wave radiation waveguides 4 and the slot plate 5 constitute a wave guide array which is arranged in plane 10. In this plasma processing apparatus 1, the flat waveguide array 10 is provided outside the vacuum chamber 6.

As the electromagnetic wave source 2, it is possible to use a microwave source which supplies a microwave of, e.g., 2.45 GHz. This electromagnetic wave source 2 is coupled with one end portion of the electromagnetic wave distribution waveguide 3.

As the electromagnetic wave distribution waveguide 3 and the plurality of electromagnetic wave radiation waveguides 4, rectangular waveguides can be used. A size (an inner shape) of each electromagnetic wave radiation waveguide 4 is set in such a manner that a height b₂ of the inner shape becomes ½ or below of a width a₁ of the inner shape. This height b₂ of the inner shape is not precisely restricted, and a slightly larger height can be used. However, when this height is tool large, a high-order mode other than a basic mode allows propagation with a frequency in which an electromagnetic wave should be propagated. On the contrary, when the height is too small, a large current flows through a waveguide wall, and a copper loss is increased. For such reasons, in a waveguide slot antenna, the height which is ½ or below of the width is preferable so that a matching slot from which last 100% power is radiated can be designed. Further, an inner shape of the electromagnetic wave distribution waveguide 3 is set to be substantially equal to the inner shape of each electromagnetic wave radiation waveguide 4.

Each electromagnetic wave radiation waveguide 4 branches in a vertical direction from an electric field surface (an E surface) or a magnetic field surface (an H surface) of the electromagnetic wave distribution waveguide 3, and the electromagnetic wave radiation waveguides 4 are closely aligned and provided in parallel without a gap therebetween. As described above, in this embodiment, since the electromagnetic wave distribution waveguide 3 is a rectangular waveguide, its waveguide surface including a long side serves as the H surface vertical to an electric field direction of an electromagnetic wave, and its waveguide surface including a short side functions as the E surface parallel with the electric field direction of the electromagnetic wave. In this embodiment, each electromagnetic wave radiation waveguide 4 branches in the vertical direction from the waveguide surface (the E surface) including the short side of the electromagnetic wave distribution waveguide 3.

Furthermore, this plasma processing apparatus 1 is configured in such a manner that the same amount of power is fed in phase to each electromagnetic wave radiation waveguide 4 through Π junction. In detail, as shown in FIGS. 1 and 4, each power feed window 21 is formed in a wall constituting the electromagnetic wave distribution waveguide 3 in accordance with a region between the adjacent electromagnetic wave radiation waveguides 4. In this embodiment, the 10 electromagnetic wave radiation waveguides 4 are provided, and hence there are provided five power feed windows 21 whose number is ½ of that of the electromagnetic wave radiation waveguides 4. Moreover, five inductive columns 22 are provided to correspond to these feed windows 21 in the electromagnetic wave distribution waveguide 3. According to this configuration, as indicated by arrows in FIG. 1, an electromagnetic wave oscillated by the electromagnetic wave source 2 and propagated through the electromagnetic wave distribution waveguide 3 is substantially vertically deflected, and subjected to Π junction into each electromagnetic wave radiation waveguide 4 in phase with the same amount of power.

Additionally, in this plasma processing apparatus 1, the electromagnetic wave radiation waveguides 4 are adjacently arranged, and each electromagnetic wave radiation waveguide cycle p satisfies the following expressions:

λ₀>p>a₂>b₂

and

p=(λ_{g1}/2)±α (where it is preferable for α to be 5% or below of λ_{g1})

Where λ₀ is a free space wavelength of the electromagnetic wave output from the electromagnetic wave source 2 (the electromagnetic wave in this embodiment) and λ_{g1} is a guide wavelength of the electromagnetic wave output from the electromagnetic wave source 2 in the electromagnetic wave distribution waveguide 3.

It is to be noted that the guide wavelength λ_{g1} of the electromagnetic wave in the electromagnetic wave distribution waveguide 3 can be obtained from Expression (1):

λ_{g1}=λ₀/{square root over (εᵣ₁−(λ₀/(2a₁))² )} (1)

### In this embodiment, since the electromagnetic wave distribution waveguide 3 is hollow, a specific inductive capacity in Expression (1) is substantially 1.

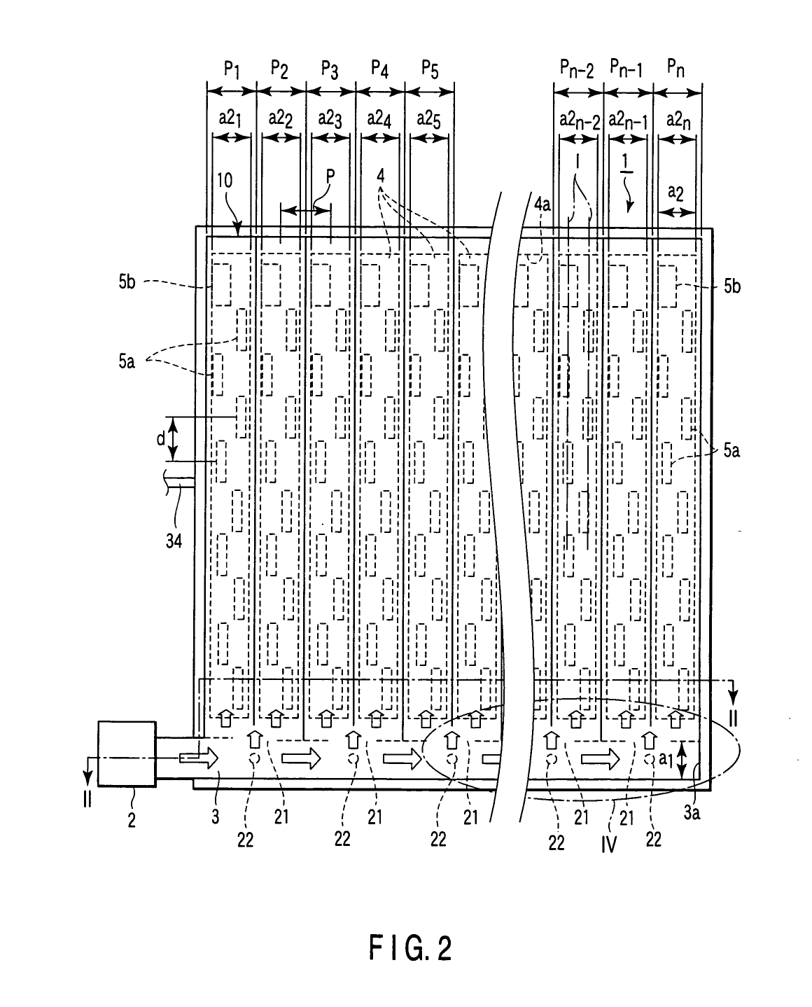

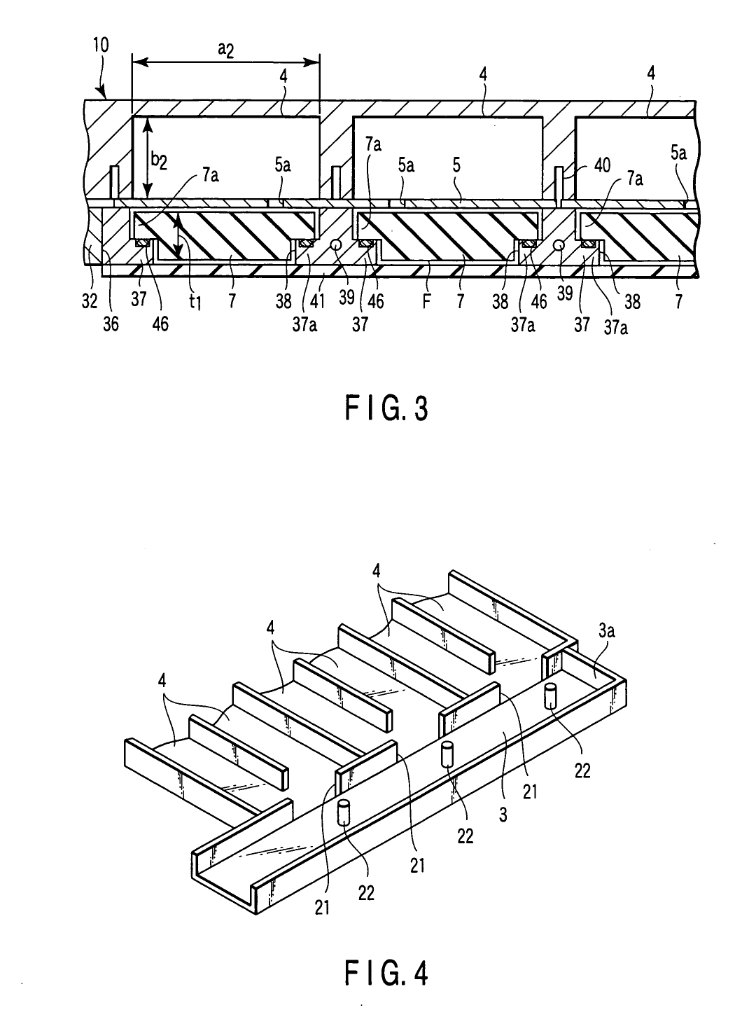

As shown in FIG. 1, in each electromagnetic wave radiation waveguide 4, the plurality of slots 5a respectively constituting a waveguide antenna are aligned and arranged in a zigzag pattern along an electromagnetic wave propagating direction. In detail, as shown in FIGS. 2 and 3, the plurality of slots 5a are formed in the slot plate 5 which defines a bottom surface of each electromagnetic wave radiation waveguide 4 (forms a bottom wall of each electromagnetic wave radiation waveguide 4).

The plurality of slots 5a provided to each electromagnetic wave radiation waveguide 4 are alternately arranged on a pair of parallel virtual lines I. Additionally, a gap d between the slots 5a which are adjacent to each other along the electromagnetic wave propagating direction (a distance between the centers of the two slots) is set to be smaller than the free space wavelength λ₀ of the electromagnetic wave oscillated from the electromagnetic wave source 2.

Further, in this embodiment, in order to radiate an excessive electromagnetic wave which cannot be distributed by using each slot 5a of each electromagnetic wave radiation waveguide 4 into the vacuum chamber 6, a matching slot 5b of the plurality of slots 5 provided to each electromagnetic wave radiation waveguide 4 is provided at the farthest position from the electromagnetic wave distribution waveguide 3. An area of this matching slot 5b is set to be larger than an area of any other slot 5a in order to eliminate reflection of the electromagnetic wave. That is, in the plasma processing apparatus 1 according to this embodiment, since the height b₂ of each electromagnetic wave radiation waveguide 4 is set to be ½ or below of the width a₂ of each electromagnetic wave radiation waveguide 4 as described above, setting a parameter of the matching slot 5b to a predetermined value enables a design in which substantially 100% of incident power can be radiated into the vacuum chamber 6.

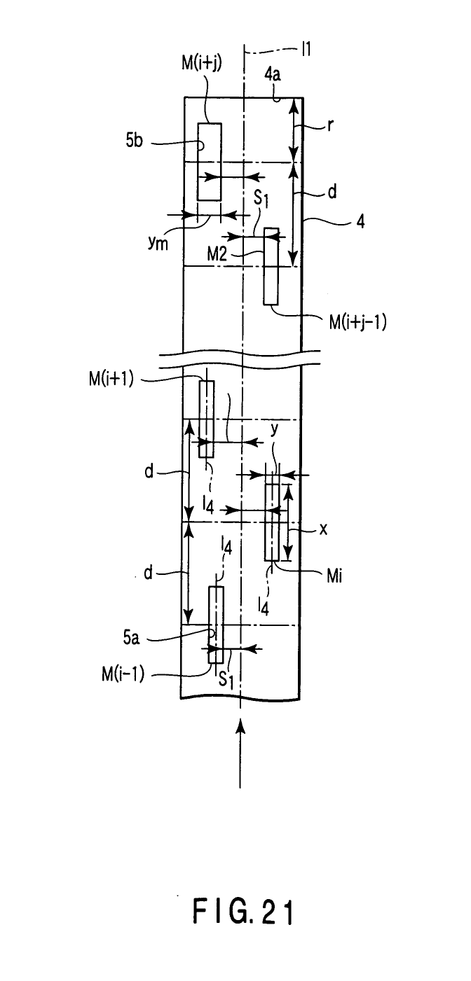

Furthermore, even if a parameter of the matching slot 5b is set to a predetermined value, a very small part of the electromagnetic wave may be possibly reflected by a trailing end 4a of each electromagnetic wave radiation waveguide 4. In order to suppress an influence of the electromagnetic wave (a reflected wave) reflected by the trailing end 4a of each electromagnetic wave radiation waveguide 4 in this manner, a distance r (see FIG. 21) between the trailing end 4a of the electromagnetic wave radiation waveguide 4 and each matching slot 5b is set to be ¼ of a guide wavelength λ_{g2} of the electromagnetic wave output from the electromagnetic wave source 2 in each electromagnetic wave radiation waveguide 4 in this embodiment.

Moreover, the plasma processing apparatus 1 according to this embodiment is designed in such a manner that the electromagnetic wave radiation waveguides 4 are adjacently and closely arranged as described above. According to this arrangement, the plurality of slots 5a are cyclically arranged in accordance with an entire region in which the electromagnetic wave radiation windows 7 are arranged. When the plurality of slots 5a are cyclically arranged in accordance with the entire region in which the electromagnetic wave radiation windows 7 are arranged, the electromagnetic wave is uniformly supplied into the vacuum chamber 6. Therefore, plasma can be uniformly generated in the vacuum chamber 6.

The flat waveguide array 10 can be manufactured as follows. First, a predetermined number of grooves each having a rectangular cross section and serving as a part of each electromagnetic wave radiation waveguide 4 are formed from a metal block such as an aluminum block. There is prepared a metal plate material having the substantially same area as that of a surface of the metal block on which the grooves are formed. The plurality of slots 5a having the above-described arrangement are opened in this plate material to correspond to the respective grooves, thereby producing the slot plate 5. A side of the metal block on which the plurality of grooves are opened is covered with the slot plate 5. As a result, the electromagnetic wave radiation waveguides 4 are formed in a region surrounded by a wall of each groove (a partition wall) and the slot plate 5, and the plurality of slots 5a are provided to each electromagnetic wave radiation waveguide 4. In this configuration, the electromagnetic wave radiation waveguides 4 adjacent to each other share one partition wall. It is to be noted that the predetermined number of rectangular waveguides which serve as the electromagnetic wave radiation waveguides 4 may be manufactured and assembled, thereby forming the flat waveguide array 10.

As shown in FIG. 2, the vacuum chamber 6 is provided with a chamber main body 31 and a top panel 32, and includes a processing chamber 6a where a substrate to be processed 100 is subjected to plasma processing. The chamber main body 31 has a bottom wall 31a and a sidewall 31b and is opened upward. The top panel 32 covers this chamber main body 31 from the upper side so that the opening of the chamber main body 31 is closed. An O-ring 31a is used as a sealing member between the chamber main body 31 and the top panel 32 so that the inside of the chamber is air-tightly maintained. It is to be noted that a solid metal gasket may be used as the sealing member as long as it is not constantly opened/closed.

The vacuum chamber 6 is formed with strength which allows depressurization in the processing chamber 6a to provide a vacuum state or a substantially vacuum state. As a material forming the vacuum chamber 6, a metal material, e.g., aluminum or stainless can be used. Additionally, a support base 33 which supports the substrate to be processed 100 is provided in the processing chamber 6a.

The chamber main body 31 has a gas introduction opening 34 from which a process gas is introduced into the processing chamber 6a and a gas discharge opening 35 from which the gas in the processing chamber 6a is discharged. The inside of the processing chamber 6a communicates with a gas cylinder (not shown) which accommodates the process gas through the gas introduction opening 34. On the other hand, the inside of the processing chamber 6a communicates with a vacuum discharge system (not shown) through the gas discharge opening 35. As the vacuum discharge system, it is possible to appropriately use a discharge type pump, e.g., a dry pump or a turbo molecular pump in accordance with a desired degree of vacuum.

As shown in FIGS. 2 and 3, the top panel 32 has an opening portion 36, and a plurality of metal beams 37 are put up at predetermined intervals to cut across this opening portion 36. These beams 37 constitute a part of the vacuum chamber 6. As a result, the opening portion 36 is divided into a plurality of elongated small openings 38 to correspond to the plurality of electromagnetic wave radiation windows 7. In this embodiment, the opening portion 36 is divided into the 10 elongated small openings 38 to respectively correspond to the 10 electromagnetic wave radiation windows 7. Each beam 37 has a window receiving portion 37a which horizontally bulges toward the central side of the elongated small opening 38 from the side surface close to the lower side.

As shown in FIGS. 2 and 3, each electromagnetic wave radiation window 7 has a bulge portion 7a which bulges in the horizontal direction from an outer peripheral surface close to the upper side, and is formed to have a substantially T-shaped cross section. Each electromagnetic wave radiation window 7 is fitted in the elongated small opening 38, and provided to the top panel 32 to close the elongated small opening 38 in a state where it is supported by the beam 37. Air tightness is held between the window receiving portion 37a of the beam 37 and the bulge portion 7a of the electromagnetic wave radiation window 7 (between the electromagnetic wave radiation window 7 and the vacuum chamber 6) by using an O-ring 46 as a sealing member.

A choke 40 is provided in accordance with the electromagnetic wave distribution waveguide 3 and at least one of the plurality of electromagnetic wave radiation waveguide 4, e.g., a predetermined electromagnetic wave radiation waveguide 4. This choke 40 can suppress the electromagnetic wave from leaking from a joint surface or the like generated when constituting the electromagnetic wave radiation waveguides 4. Therefore, a processing accuracy or a joining method when constituting the electromagnetic wave radiation waveguides 4 can be facilitated.

Additionally, heat generated by plasma heats the O-ring used for maintaining air tightness, which may possibly result in deterioration. In such a plasma processing apparatus 1, it is preferable to provide cooling means. In the plasma processing apparatus 1 according to this embodiment, a water-cooled tube 39 as cooling means is provided between the electromagnetic wave radiation windows 7, i.e., in each beam 37 holding each electromagnetic wave radiation window 7. This cooling means can efficiently cool the O-ring or the like without obstructing generation of plasma.

Meanwhile, as described above, when the electromagnetic wave radiation windows 7 are separately provided, each beam 37 formed of a conductor (formed of a metal) is exposed in the vicinity of an electromagnetic wave incidence surface F from which the electromagnetic wave enters the vacuum chamber 6, i.e., one of outer surfaces of the electromagnetic wave radiation window 7 which is provided on the inner side of the vacuum chamber 6. Therefore, plasma is hard to spread into or in the vicinity of each beam 37.

In order to facilitate spread of the plasma into and in the vicinity of each beam 37, it is preferable to perform a process of covering at least a part of each beam 37 exposed in the vacuum chamber 6 (in the processing chamber 6a) with a covering dielectric member 41 to suppress elimination of electrons or the like in the plasma in each beam 37 (a metal). In the plasma processing apparatus 1 according to this embodiment, the part of each beam 37 exposed in the vacuum chamber 6 and the electromagnetic wave incidence surface F of each electromagnetic wave radiation window 7 are covered with the covering dielectric member 41. As the covering dielectric member 41, it is possible to preferably use, e.g., quartz, a fluorocarbon resin, alumina or the like, but the present invention is not restricted thereto. Using the dielectric member 41 in this manner can excellently diffuse the plasma in the vacuum chamber 6.

Further, when the inside of the vacuum chamber 6 is set in a low pressure state, a force having a pressure difference between a substantially atmospheric pressure and a substantially low vacuum pressure, e.g., approximately 9.80665×10⁴ Pa (1 kg/cm²) is applied to each electromagnetic wave radiation window 7. Therefore, a thickness t₁ of each electromagnetic wave radiation window 7 must be set to a thickness which can resist this differential pressure.

As shown in the following Table 1, when each electromagnetic wave radiation window 7 is formed of, e.g., a synthetic quartz plate having a circular shape with a diameter of 300 mm or a rectangular shape of 250 mm×250 mm, a thickness of approximately 30 mm is required for the electromagnetic wave radiation window 7. However, when the thickness of the electromagnetic wave radiation window 7 is increased, a loss of the electromagnetic wave becomes large. Furthermore, in case of the plasma processing apparatus 1 corresponding to a large substrate of approximately 1 m×1 m, the thickness of the electromagnetic wave radiation window 7 becomes too large, and supporting the electromagnetic wave radiation window 7 is thereby impossible because of its weight.

TABLE 1

| | Window size | | | |
|---|---|---|---|---|
| | Diameter of | Diameter of | 250 mm × | |
| | 6 inches | 300 mm | 250 mm | 300 mm × 300 mm |
| Synthetic | 14.3 mm | 30 mm | 30.6 mm | 36.8 mm |
| quartz | | | | |
| board | | | | |
| thickness | | | | |

Therefore, in this embodiment, 10 electromagnetic wave radiation windows 7 having a size of 100 cm×9 cm are provided so that a vacuum is held between the 10 electromagnetic wave radiation windows 7 and the vacuum chamber 6.

As shown in FIGS. 2 and 3, each electromagnetic wave radiation waveguide 4 is provided to face each electromagnetic wave radiation waveguide 4 outside the vacuum chamber 6. That is, the plurality of slots 5a provided to each electromagnetic wave radiation waveguide 4 are provided to respectively face the electromagnetic wave radiation window 7.

A relationship between each electromagnetic wave radiation window 7 and each electromagnetic wave radiation waveguide 4 in the plasma processing apparatus 1 according to this embodiment will now be described.

Each electromagnetic wave radiation window 7 is formed to have a width substantially equal to the width a₂ of the electromagnetic wave radiation waveguide 4 or a width narrower than the width a₂ of the electromagnetic wave radiation waveguide 4 in accordance with each electromagnetic wave radiation waveguide 4. Moreover, each electromagnetic wave radiation window 7 and each electromagnetic wave radiation waveguide 4 are designed in such a manner that a length of the electromagnetic wave radiation waveguide 4 in the longitudinal direction substantially matches with a length of the electromagnetic wave radiation window 7 in the longitudinal direction. Additionally, a positional relationship between these members is determined in such a manner that the longitudinal direction of the electromagnetic wave radiation waveguide 4 substantially matches with the longitudinal direction of the electromagnetic wave radiation window 7. According to this configuration, the electromagnetic wave can be effectively introduced into the vacuum chamber 6 without preventing the electromagnetic wave by each beam 37 although the electromagnetic wave radiation windows 7 are separately provided.

It is to be noted that the length of the electromagnetic wave radiation window 7 in the longitudinal direction may be shorter than the length of the electromagnetic wave radiation waveguide 4 in the longitudinal direction. In this case, the beams 37 of the top panel 32 of the vacuum chamber 6 which support the electromagnetic wave radiation windows 7 can be formed to cross vertically and horizontally. That is, since each electromagnetic wave radiation window 7 smaller than the length of each electromagnetic wave radiation waveguide 4 in the longitudinal direction can be formed, the thickness t₁ of the electromagnetic wave radiation window 7 can be further reduced.

A description will now be given on an examination result about a size of each electromagnetic wave radiation waveguide 4 used in the flat waveguide array 10 having a size of 1000 mm×1000 mm. In this embodiment, an electromagnetic wave source having a frequency of 2.45 GHz which is most commonly distributed was used as the electromagnetic wave source 2 to design a size of each electromagnetic wave radiation waveguide 4, the number of slots 5a and others in accordance with the following procedure. It is to be noted that the design was made on the assumption that there is no influence of the metal beams 37.

An examination was carried out with respect to the width a₂ of each electromagnetic wave radiation waveguide 4 and designable minimum value and maximum value of the electromagnetic wave radiation waveguide cycle p substantially corresponding to the width a₂. As a result of examination, if a uniform opening distribution is realized by using a communication antenna placed in a free space having no plasma, a design enabled range of the electromagnetic wave radiation waveguide cycle p is set to approximately 65 mm to approximately 110 mm considering occurrence of a side lobe (deterioration in directivity) which is called a grating lobe.

As described above, according to the plasma processing apparatus 1 of this embodiment, a propagating direction of the electromagnetic wave is bent at a substantially right angle and distributed from the electromagnetic wave distribution waveguide 3 to each electromagnetic wave radiation waveguide 4, and the electromagnetic wave can be excellently distributed to many electromagnetic wave radiation waveguides 4. According to this embodiment, it is possible to design the plasma processing apparatus 1 which can cope with the substrate to be processed 100 having a large area. Further, since a footprint of a branch portion is small, a footprint of the apparatus can be reduced. Furthermore, the electromagnetic wave distribution waveguide 3 and each electromagnetic wave radiation waveguide 4 are provided on the same plane. That is, the plasma processing apparatus 1 according to this embodiment is a one-layer type. Therefore, a height of the apparatus can be reduced to provide a compact shape as compared with a multilayer type in which the electromagnetic wave distribution waveguide 3 and each electromagnetic wave radiation waveguide 4 are provided in an overlapping manner.

Moreover, since the same amount of power is fed in phase to each electromagnetic wave radiation waveguide 4 through the II junction, the number of the branch portions of the electromagnetic wave distribution waveguide 3 and each electromagnetic wave radiation waveguide 4 can be reduced to ½ of the number of the electromagnetic wave radiation waveguides 4. Therefore, the configuration of the electromagnetic wave distribution waveguide 3 can be simplified.

Additionally, since the plurality of electromagnetic wave radiation windows 7 are provided to respectively correspond to the plurality of electromagnetic wave radiation waveguides 4, the thickness t₁ of the electromagnetic wave radiation window 7 can be reduced as compared with that in the prior art. Therefore, the large plasma processing apparatus 1 can be realized, and the substrate having a large area can be processed with a uniform plasma density.

In the plasma processing apparatus 1 according to this embodiment, the electromagnetic wave is distributed to the plurality of electromagnetic wave radiation waveguides 4 which branch from the linear electromagnetic wave distribution waveguide 3 at a substantially right angle and are closely aligned in parallel. Therefore, the electromagnetic wave can be radiated with a uniform energy density toward the substrate to be processed 100 side from the slots 5a through the electromagnetic radiation windows 7 even in case of the rectangular substrate to be processed 100 having a large area. Therefore, plasma having a uniform plasma density can be generated.

Further, according to the plasma processing apparatus 1 of this embodiment, the electromagnetic wave radiation waveguide cycle p satisfies the relationship of λ₀>p>a₂>b₂ and p=(λ_{g1}/2)±α (where it is preferable for α to be 5% or below of λ_{g1}). Therefore, occurrence of a grating lobe can be suppressed. Furthermore, each electromagnetic wave radiation waveguide 4 can be arranged at a position where an amplitude of a wavelength of the electromagnetic wave always becomes fixed. Therefore, feeding of power to each electromagnetic wave radiation waveguide 4 can be easily adjusted. Moreover, since the slot gap d satisfies the relationship of λ₀>d, occurrence of a grating lobe can be suppressed.

Additionally, in this embodiment, since the electromagnetic wave is supplied to the plurality of electromagnetic wave radiation waveguides 4 from one electromagnetic wave source 2 through the electromagnetic wave distribution waveguide 3, a frequency of the electromagnetic wave is the same in all the electromagnetic wave radiation waveguides 4. Therefore, an antenna which radiates a uniform energy density can be readily designed. When a frequency of the electromagnetic wave supplied to each electromagnetic wave radiation waveguide 4 differs, the antenna must be designed while taking an interference of the electromagnetic wave into consideration, which results in a complicated work.

Further, since each electromagnetic wave radiation window 7 is provided to correspond to the plurality of slots 5a, a processing cost of the top panel 32 of the vacuum chamber 6 can be reduced, thereby decreasing a price of the apparatus.

It is to be noted that the plasma processing apparatus 1 according to this embodiment can perform plasma oxidation, plasma film formation, plasma etching or plasma ashing as plasma processing. Furthermore, using the plasma processing apparatus 1 according to this embodiment can excellently perform plasma processing of the rectangular substrate to be processed 100 having a large area. Moreover, since the plasma generated in the plasma processing apparatus 1 according to this embodiment has a high electron density, a low electron temperature and excellent uniformity, it is possible to provide a very good plasma processing method of plasma oxidation, plasma etching or plasma film formation.

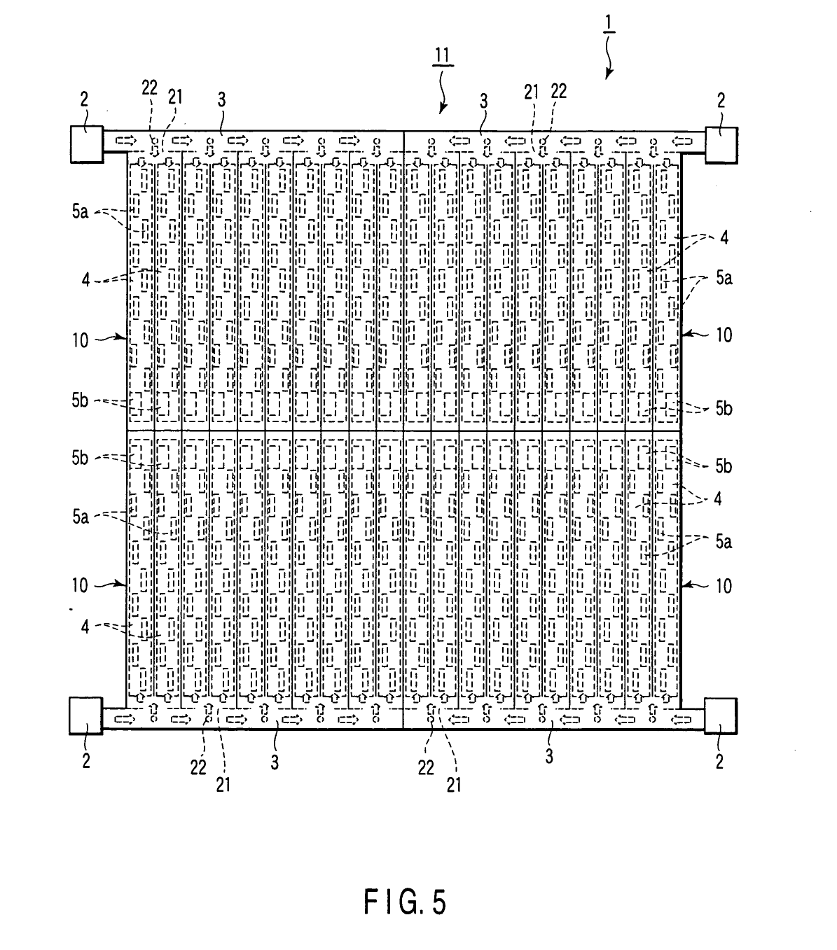

A second embodiment according to the present invention will now be described hereinafter with reference to FIG. 5.

In a plasma processing apparatus 1 according to this embodiment, combining four flat waveguide arrays 10 used in the plasma processing apparatus 1 according to the first embodiment constitutes one large flat waveguide array 11. A vacuum chamber 6 is formed to correspond to this large flat waveguide array 11. It is to be noted that any other structures including non-illustrated structures are the same as those in the first embodiment, and hence like reference numerals denote the same parts, thereby eliminating the tautological explanation.

Like this embodiment, preparing four electromagnetic wave sources 2 can cope with an area which is four times an area in a case where one electromagnetic wave source 2 is provided. That is, combining the plurality of flat waveguide arrays 10 having the same shape can readily design the plasma processing apparatus 1 which can perform plasma processing with respect to a substrate to be processed 100 having a large area.

In this embodiment, a range which is within ±5% of a guide guide wavelength λ_{g1} of an electromagnetic wave distribution waveguide is provided with respect to a cycle p in which electromagnetic wave radiation waveguides are aligned. Since electromagnetic wave radiation waveguides are arranged every ½ guide wavelength of the electromagnetic wave distribution waveguide, p=λ_{g1}/2 is ideally desirable, but a deviance is produced due to a processing accuracy or the like at the time of manufacture in reality. How far this deviance can be allowed is determined by a wavelength of a wave which is propagated through each waveguide. If a deviance is approximately 10% of a wavelength, coupling from the distribution waveguide to the electromagnetic wave radiation waveguide is not greatly affected. Thus, a range of p is determined as ±α (α is within 5% of λ_{g1}). A width a₂ in the electromagnetic wave radiation waveguide is expressed as a₂=p−d using p and a waveguide wall thickness d. Further, since d>0, if there is no unevenness in p, p>a₂ is always achieved.

However, if a deviance is produced in a value of p, a deviance is also generated in a value of the width a₂ in the electromagnetic wave radiation waveguide. In this case, the relationship of p>a₂ may not be achieved in a relationship of λ₀>p>a₂>b₂.

This case will now be described hereinafter.

FIG. 1 shows cases where an interval p of the electromagnetic wave radiation waveguides becomes maximum (p1=1.1 p) and where it becomes minimum (p2=0.9 p) under the condition of ±α (α is within 5% of λ_{g1}). Furthermore, a2₁ is a value of a₂ in the same waveguide as that of p1, and a2₂ is a value of a₂ in the same waveguide as that of p2. In this case, when d is fixed, a2₁ is a maximum value of a₂, and a22 is a minimum value of a₂. When p and a₂ are measured in the same electromagnetic wave radiation waveguide, p1>a2₁ and p2>a2₂ are achieved for the reason mentioned above, and a discrepancy from contents of claim 2 is not produced.

However, when the minimum value p2 is measured as a dimension of p and the maximum value a2₁ is measured as a dimension of a₂, p>a₂ is not achieved in some cases.

Considering conditions for such a case when d is fixed, the following expression can be obtained:

a2₁−p2≧0

When this relationship is expressed by using p and the waveguide board thickness d, the following expression can be attained:

$$\begin{matrix}a {2}_{1} - p 2 = ( 1.1 p - d ) - 0.9 p \\ = 0.2 p - d \geq 0\end{matrix}$$

$$0.2 p \geq d$$

When 0.2 p≧d is achieved, p≦a₂ is obtained. For example, when manufacture is performed with values of p=110 mm and d=20 mm which are figures allowing actual production, this condition is satisfied.

Thus, when a deviance due to a processing accuracy or the like is allowed with respect to p, p and a₂ are defined by the following relational expression.

As shown in FIG. 2, numbering from 1 to n is performed with respect to n electromagnetic wave radiation waveguides aligned in parallel with each other. p corresponding to each number is set as pₘ (m=an integer from 1 to n), a₂ corresponding to the same is set as a2ₘ (m=an integer from 1 to n), and the following relationships are determined:

λ₀>pₘ>a2ₘ>b₂ (m=an integer from 1 to n)

and,

pₘ=(λ_{g1}/2)±α (where α is within 5% of λ_{g1})

### In this case, even if a deviance is produced in a dimension of p due to a processing accuracy or the like, the above-described relational expressions are always achieved.

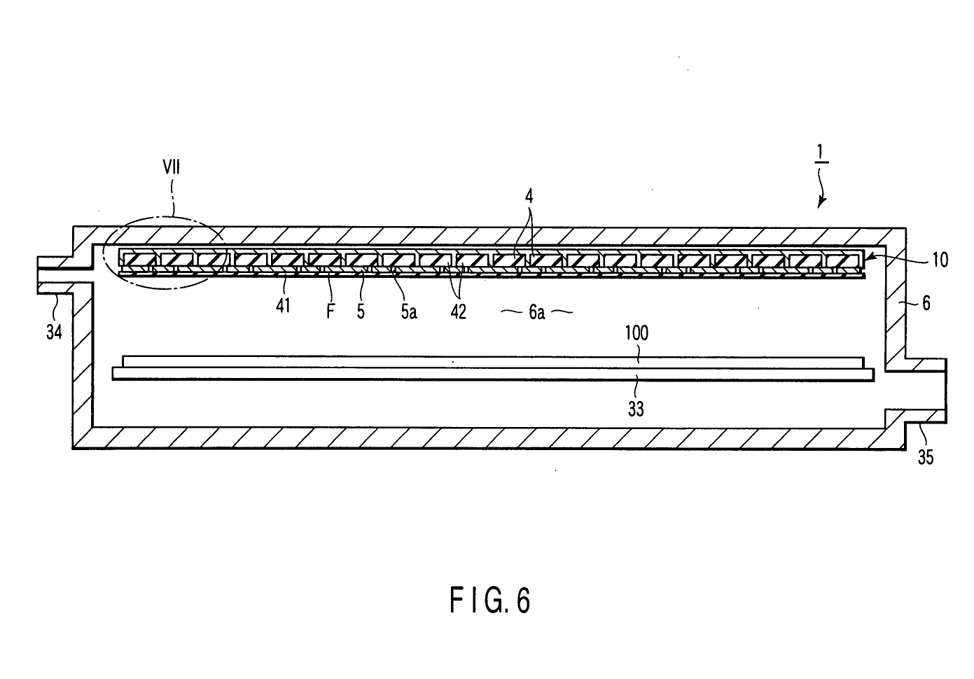

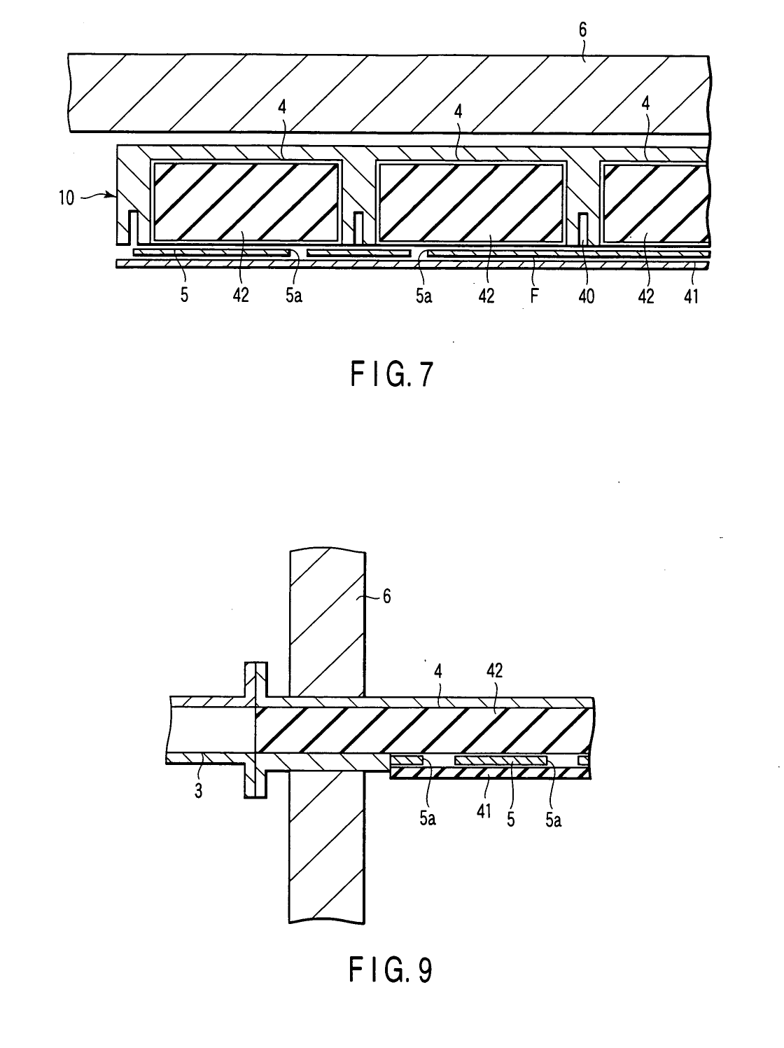

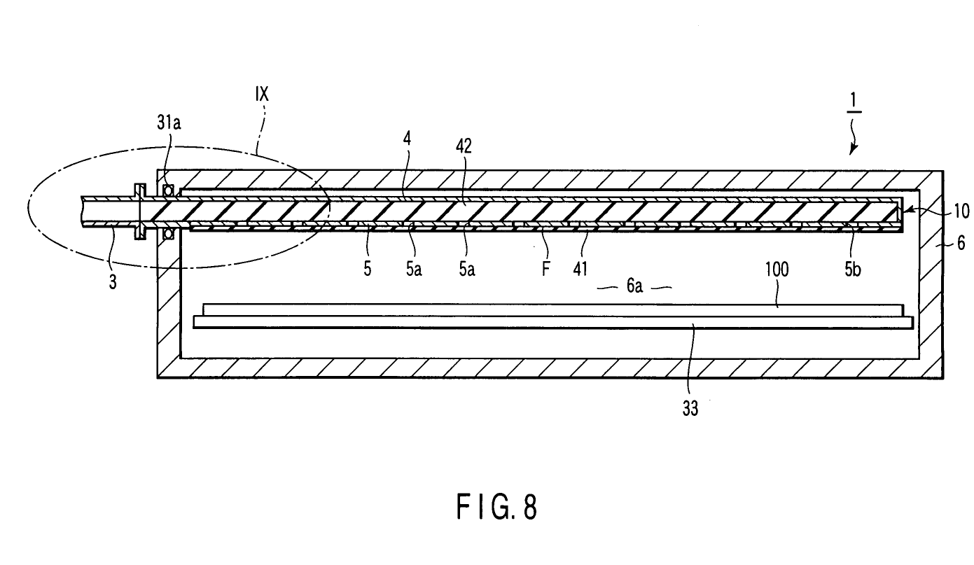

A third embodiment according to the present invention will now be described hereinafter with reference to FIGS. 6 to 9.

In a plasma processing apparatus 1 according to this embodiment, each electromagnetic wave radiation waveguide 4 is provided in a vacuum chamber 6. Furthermore, in order to suppress plasma generated in the vacuum chamber 6 from entering each electromagnetic wave radiation waveguide 4 or an electromagnetic wave distribution waveguide 3, a first dielectric member 42 is provided in each electromagnetic wave radiation waveguide 4.

In detail, as shown in FIGS. 6 to 9, the plasma processing apparatus 1 according to this embodiment is provided with an electromagnetic wave source 2, an electromagnetic wave distribution waveguide 3, a plurality of, e.g., 20 electromagnetic wave radiation waveguides 4, a slot plate 5, a vacuum chamber 6 and others. The electromagnetic wave radiation waveguides 4 and the slot plate 5 constitute a flat waveguide array 10. In this plasma processing apparatus 1, the flat waveguide array 10 is provided in the vacuum chamber 6, and the electromagnetic wave distribution waveguide 3 and each electromagnetic wave radiation waveguide 4 are coupled through a sidewall 31b of the vacuum chamber 6.

As the electromagnetic wave distribution waveguide 3 and the plurality of electromagnetic wave radiation waveguides 4, it is possible to use, e.g., a rectangular waveguide. A first dielectric member 42 is provided to fill the inside of each electromagnetic wave radiation waveguide 4. As the first dielectric member 42, for example, quartz (synthetic quartz), a fluorocarbon resin, alumina or the like is preferable, but the present invention is not restricted to these materials. In the plasma processing apparatus 1 according to this embodiment, each electromagnetic wave radiation waveguide 4 is set in such a manner that a height b₂ of its inner shape becomes ½ or below of a width a₂ of the inner shape, and the first dielectric member 42 formed of synthetic quartz is provided in each electromagnetic wave radiation waveguide 4.

Meanwhile, since a frequency of an electromagnetic wave is transmitted in a basic mode in a rectangular waveguide, the plasma processing apparatus 1 can be realized by designing to satisfy the following condition:

(λ/ε^{0.5})<2a (8)

where ε is a specific inductive capacity in the rectangular waveguide, a is a long diameter of an inner shape dimension of the rectangular waveguide, and λ is a guide wavelength of the electromagnetic wave.

As described above, the inside of the electromagnetic wave distribution waveguide 3 is filled with air (a specific inductive capacity Ε=approximately 1). The inside of each electromagnetic wave radiation waveguide 4 is filled with the first dielectric member 42 (the synthetic quartz, a specific inductive capacity ε=approximately 3.8). That is, a specific inductive capacity εᵣ₁ of a dielectric material in the electromagnetic wave distribution waveguide 3 is approximately 1, and a specific inductive capacity εᵣ₂ of a dielectric material in each electromagnetic wave radiation waveguide 4 is approximately 3.8. Additionally, the electromagnetic wave distributed from the electromagnetic wave distribution waveguide 3 is propagated through the first dielectric member 42 provided in each electromagnetic wave radiation waveguide 4.

Therefore, an inner shape dimension (the width a₂ and the height b₂) of each electromagnetic wave radiation waveguide 4 must be a size obtained by dividing an inner shape dimension (the width a₁ and the height b₁) of each electromagnetic wave radiation waveguide 4 by a square root of the specific inductive capacity of the first dielectric member 42. Specifically, since the synthetic quartz has a specific inductive capacity of approximately 4, it is preferable to set the width al and the height b₁ of each electromagnetic wave radiation waveguide 4 to dimensions which are approximately two times the width a₂ and the height b₂ of the electromagnetic wave radiation waveguide 4. The slot plate 5 which defines a bottom surface (forms a bottom wall) of each electromagnetic wave radiation waveguide 4 is provided in the vacuum chamber 6. Providing the first dielectric member 42 in each electromagnetic wave radiation waveguide 4 can suppress plasma generated in the vacuum chamber 6 from entering each electromagnetic wave radiation waveguide 4 or the electromagnetic wave distribution waveguide 3.

A covering dielectric member 41 is provided in the vacuum chamber 6 to cover the metal slot plate 5 so that plasma can be excellently diffused in the vacuum chamber 6. It is to be noted that, for example, quartz (synthetic quartz), a fluorocarbon resin, alumina or the like can be used as the covering dielectric member 41, but the present invention is not restricted to these materials.

Moreover, an O-ring 31a as a sealing member is provided between the electromagnetic wave radiation waveguides 4 and the vacuum chamber 6, thereby maintaining air tightness of the vacuum chamber 6. It is to be noted that any other structures including non-illustrated structures are the same as those in the first embodiment, and hence like reference numerals denote corresponding parts, thereby eliminating the tautological explanation.

According to this embodiment, like the first embodiment, the substrate to be processed 100 having a large area can be processed, and it is possible to obtain the compact plasma processing apparatus 1 having a small footprint and a small apparatus height.

Additionally, the first dielectric member 42 is provided in each electromagnetic wave radiation waveguide 4. Therefore, the plasma generated in the vacuum chamber 6 can be suppressed from entering each electromagnetic wave radiation waveguide 4 or the electromagnetic wave distribution waveguide 3.

Further, air tightness of the vacuum chamber 6 is held between the electromagnetic wave radiation waveguides 4 and the vacuum chamber 6. Therefore, sealing means can be set to an approximately cross section of the electromagnetic wave radiation waveguides 4.

Furthermore, since the slot plate 5 is covered with the covering dielectric member 41, a surface wave can be propagated. Moreover, since the covering dielectric member 41 is provided in the vacuum chamber 6, it is not necessary to increase strength by increasing a board thickness of the covering dielectric member 41 even if the apparatus is increased in size, for example. Therefore, there is no increase in cost due to the covering dielectric member 41. Additionally, an influence of an increase in board thickness of the covering dielectric member 41, i.e., an influence of the covering dielectric member 41 on propagation of the electromagnetic wave does not vary, thereby facilitating an apparatus design for providing uniform radiation of the electromagnetic wave. Therefore, the substrate can be processed by using the stable and uniform plasma even in case of the substrate having a large area.

Further, since it is not necessary to provide electromagnetic wave radiation windows (corresponding to the electromagnetic wave radiation windows 7 in the first embodiment) formed of a dielectric material such as synthetic quartz to the vacuum chamber 6, the electromagnetic radiation windows or the sealing means between the electromagnetic radiation windows and the wall of the vacuum chamber 6 can be all eliminated. Therefore, the configuration of the vacuum chamber 6 and the plasma apparatus itself can be further simplified.

Furthermore, since each electromagnetic wave radiation window itself can be eliminated, of course, strength (a thickness of the synthetic quartz window) of the electromagnetic wave radiation window does not have to be taken into consideration. Therefore, it is possible to readily design the plasma processing apparatus 1 provided with the large vacuum chamber 6 corresponding to the substrate to be processed 100 having a large area. Moreover, there is no increase in cost involved by growth in size of each electromagnetic wave radiation window. Additionally, since an influence of each electromagnetic wave radiation window on propagation of the electromagnetic wave can be eliminated, a design of the apparatus capable of uniformly radiating the electromagnetic wave into the vacuum chamber 6 can be facilitated. Therefore, there can be obtained the plasma processing apparatus 1 which can perform plasma processing with respect to the substrate to be processed 100 like a substrate having a large area by using the stable and uniform plasma.

Further, providing the covering dielectric member 41 to cover the slot plate 5 allows a surface wave to propagate in the vacuum chamber 6. Furthermore, the covering dielectric member 41 covers the slot plate 5 from the inner side of the vacuum chamber 6. Even if the apparatus is increased in size, a board thickness or the like of the covering dielectric member does not have to be changed. Therefore, a cost of the covering dielectric member 41 is not increased, and an influence of the covering dielectric member 41 on the electromagnetic wave is not changed. Moreover, since a design of the apparatus for uniform radiation of the electromagnetic wave is easy, it is possible to perform plasma processing by using the stable and uniform plasma even if the processing target substrate 100 is a substrate having a large area.

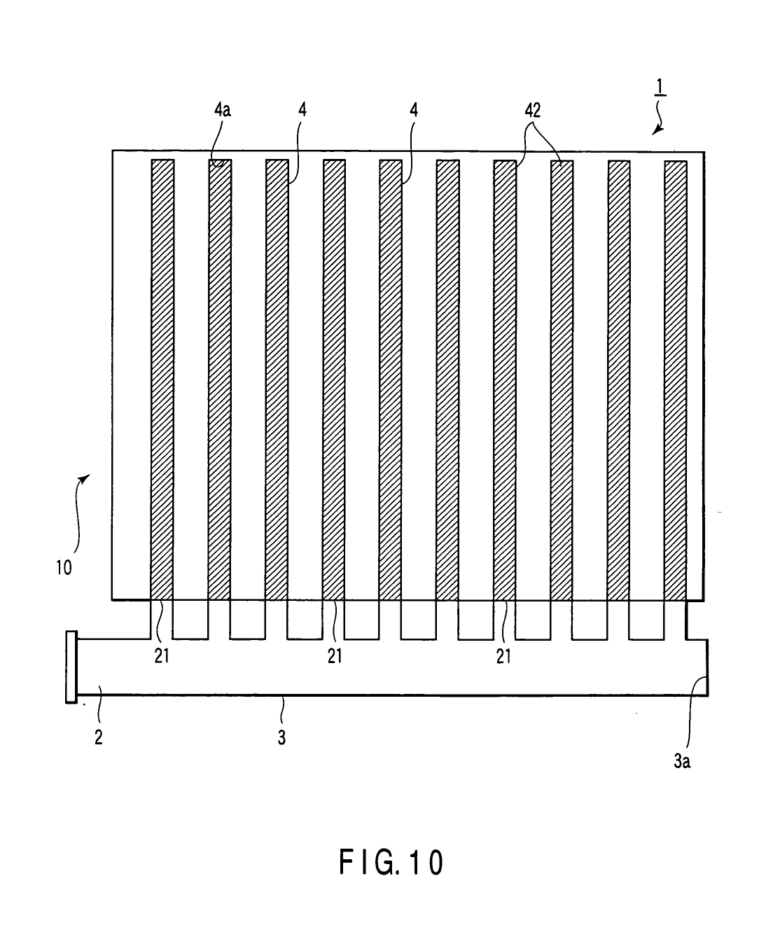

A fourth embodiment according to the present invention will now be described with reference to FIG. 10.

In a plasma processing apparatus 1 according to this embodiment, each electromagnetic wave radiation waveguide 4 is provided in a vacuum chamber 6. The plurality of, e.g., 10 electromagnetic wave radiation waveguides 4 are aligned and arranged in parallel in a state where a gap is provided between the adjacent electromagnetic wave radiation waveguides 4. In this embodiment, a width a₂ of each electromagnetic wave radiation waveguide 4 is 9 cm, whereas a distance between inner surfaces of the adjacent electromagnetic wave radiation waveguides 4 is 3 cm. A first dielectric member 42 is provided in each electromagnetic wave radiation waveguide 4. It is to be noted that hatching is provided in each region where the first dielectric member 42 is provided in FIG. 10 for better understanding.

Additionally, a power feed window 21 is provided at a coupling part of each electromagnetic wave radiation waveguide 4 and an electromagnetic wave distribution waveguide 3. Further, power is fed in phase or in reversed phases to each electromagnetic wave radiation waveguide 4 from the electromagnetic wave distribution waveguide 3 through T junction. It is to be noted that any other structures including non-illustrated structures are the same as those in the third embodiment, and hence like reference numerals denote corresponding parts, thereby eliminating the tautological explanation.

A light emission state of plasma characteristics generated while changing each gap between the adjacent electromagnetic wave radiation waveguides 4 in many ways was observed by using a CCD camera set on a lower surface of the vacuum chamber 6. As a result, it was revealed that plasma can be uniformly generated in the vacuum chamber 6 in a state where the distance between the adjacent electromagnetic wave radiation waveguides 4 is shorter than a long side of an inner shape of each electromagnetic wave radiation waveguide 4 (the width a₂ in this embodiment). Consequently, it was found that it is preferable to arrange each electromagnetic wave radiation waveguide 4 in such a manner that the distance between the inner surfaces of the adjacent electromagnetic wave radiation waveguides 4 becomes equal to or smaller than a longer inside diameter of each electromagnetic wave radiation waveguide 4.

Like the plasma processing apparatus 1 according to this embodiment, a gap may be provided between the adjacent electromagnetic wave radiation waveguides 4, and the same effects as those of the third embodiment can be obtained even if this configuration is adopted.

A fifth embodiment according to the present invention will now be described hereinafter with reference to FIG. 11.

In a plasma processing apparatus 1 according to this embodiment, each electromagnetic wave radiation waveguide 4 is provided in a vacuum chamber 6. The plurality of, e.g., 20 electromagnetic wave radiation waveguides 4 are closely aligned and arranged in parallel. A first dielectric member 42 is provided in each electromagnetic wave radiation waveguide 4. Further, a second dielectric member 43 is provided in an electromagnetic wave distribution waveguide 3. It is to be noted that hatching is provided in each region where the first and second dielectric members 42 and 43 are provided in FIG. 11 for better understanding.

As the second dielectric member 43, for example, quartz (synthetic quartz), a fluorocarbon resin, alumina or the like is preferable. However, the present invention is not restricted to these materials. In this embodiment, the second dielectric member 43 formed of synthetic quartz is provided in the electromagnetic wave distribution waveguide 3. Therefore, an electromagnetic wave oscillated by an electromagnetic wave source 2 is propagated through the second dielectric member 43 in the electromagnetic wave distribution waveguide 3, distributed to each electromagnetic wave radiation waveguide 4, propagated through the first dielectric member 42 in each electromagnetic wave radiation waveguide 4, transmitted through each slot 5a and radiated into the vacuum chamber 6 from each slot 5a.

Furthermore, in the plasma processing apparatus 1 according to this embodiment, a specific inductive capacity εᵣ₁ in the electromagnetic wave distribution waveguide 3 is substantially equal to a specific inductive capacity εᵣ₂ in each electromagnetic wave radiation waveguide 4. Therefore, an inner shape of the electromagnetic wave distribution waveguide 2 can be set to be a size substantially equal to an inner shape of each electromagnetic wave radiation waveguide 4.

Moreover, each power feed window 21 is provided at a coupling part of each electromagnetic wave radiation waveguide 4 and the electromagnetic wave distribution waveguide 3. Additionally, power is fed in phase or in reversed phases to each electromagnetic wave radiation waveguide 4 from the electromagnetic wave distribution waveguide 3 through T junction. It is to be noted that any other structures including non-illustrated structures are the same as those in the third embodiment, and hence like reference numerals denote corresponding parts, thereby eliminating the tautological explanation.

According to the plasma processing apparatus 1 of this embodiment, the same effects as those of the third embodiment can be obtained. In the plasma processing apparatus 1 according to this embodiment, the second dielectric member 43 is provided in the electromagnetic wave distribution waveguide 3, the inner shape of the electromagnetic wave distribution waveguide 3 can be set to a size substantially equal to the inner shape of each electromagnetic wave radiation waveguide 4, and the coupling structure between the electromagnetic wave distribution waveguide 3 and each electromagnetic wave radiation waveguide 4 can be thereby simplified.

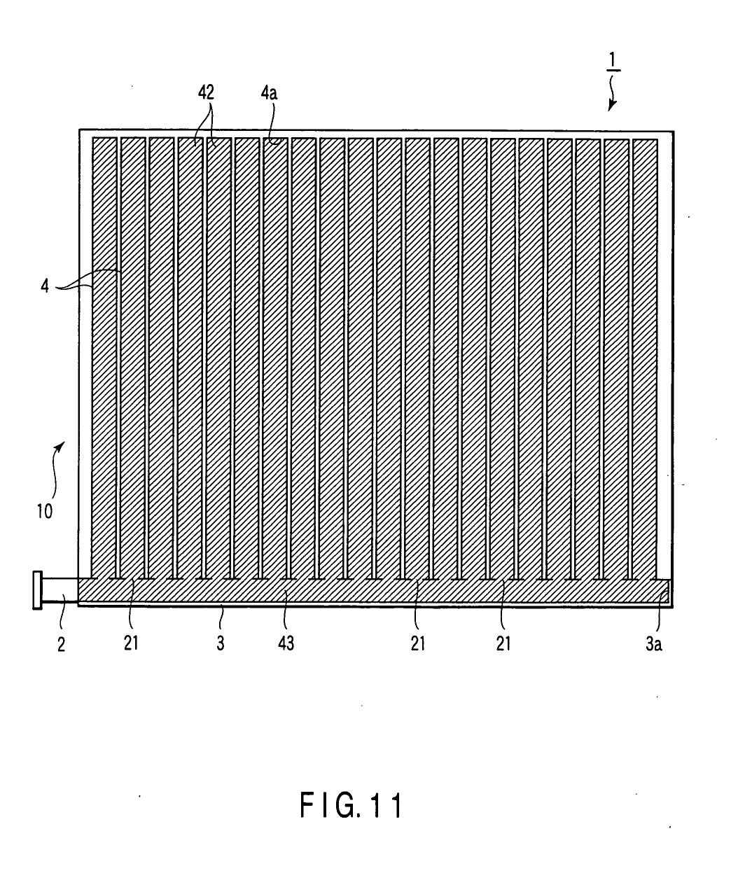

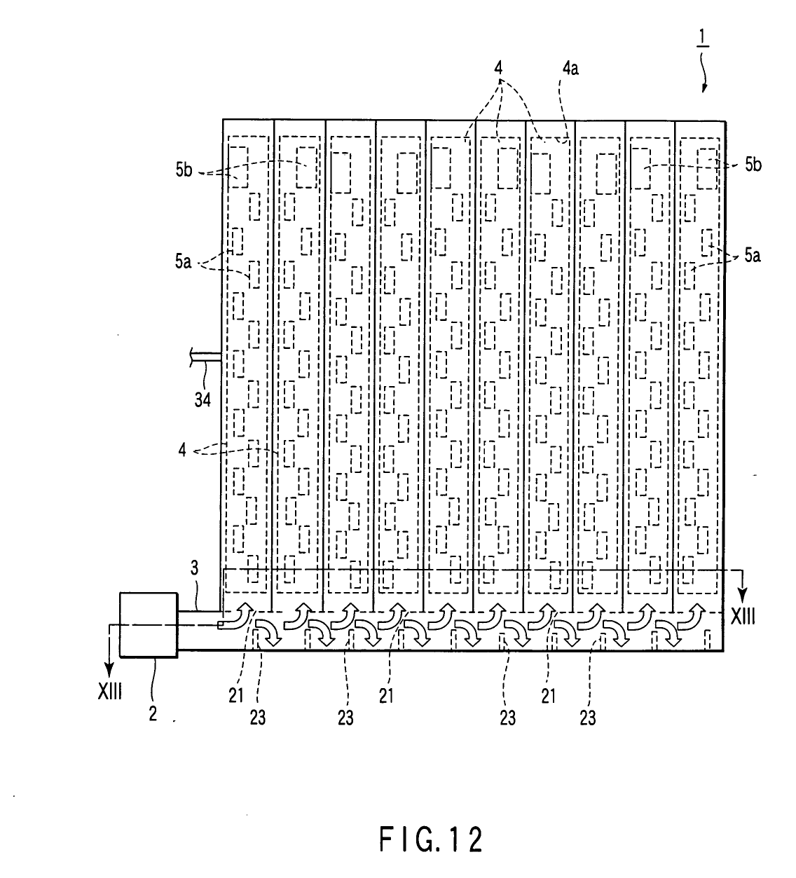

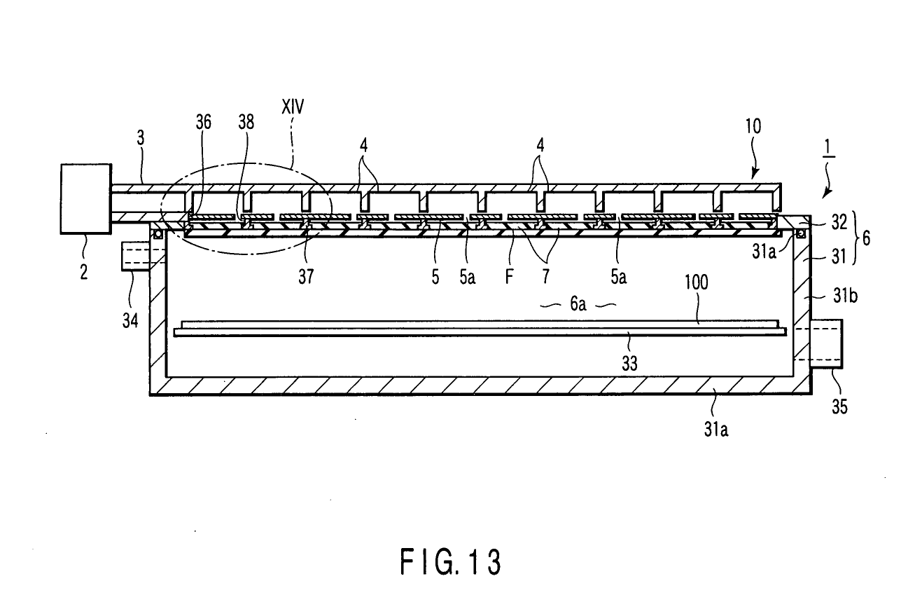

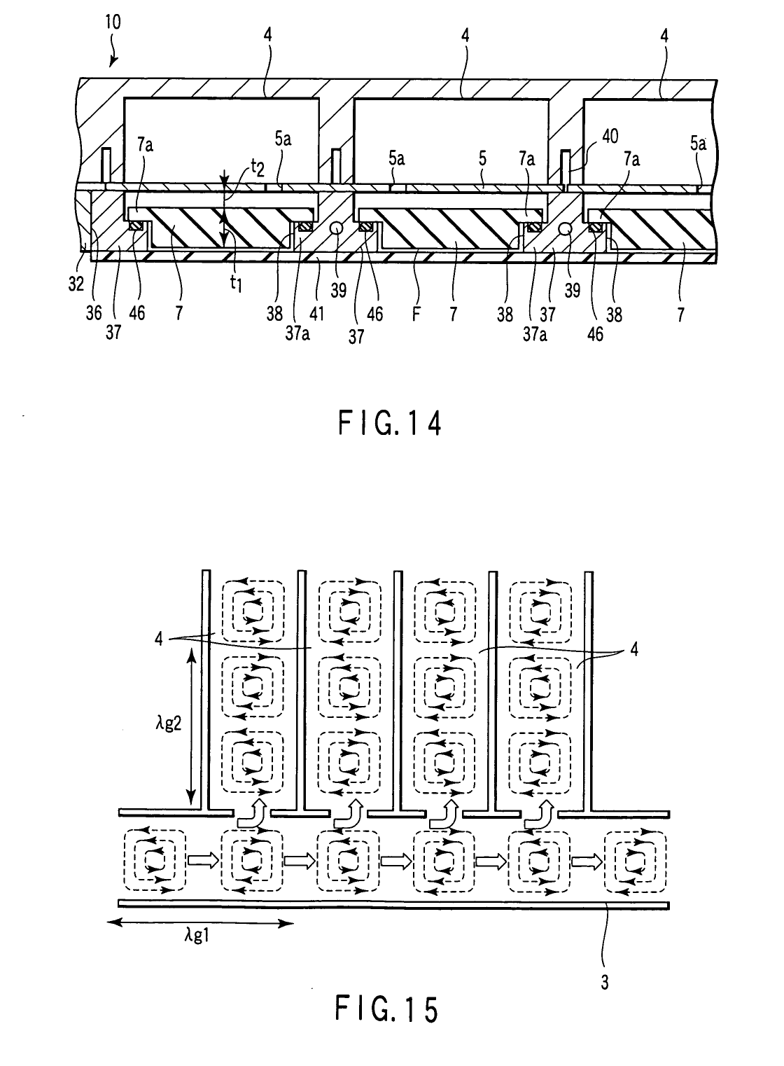

A sixth embodiment according to the present invention will now be described hereinafter with reference to FIGS. 12 to 15.

In the plasma processing apparatus 1 of this embodiment, each electromagnetic wave radiation waveguide 4 is provided outside a vacuum chamber 6. Furthermore, this plasma processing apparatus 1 feeds the same amount of power in reversed phases to the electromagnetic wave radiation waveguides 4 adjacent to each other.

In detail, an electromagnetic wave radiation waveguide cycle p is set to ½ of a guide wavelength λ_{g1} of an electromagnetic wave output from an electromagnetic wave source 2 in an electromagnetic wave distribution waveguide 3. A plurality of power feed windows 21 which allow the magnetic wave distribution waveguide 3 to communicate with the respective electromagnetic wave radiation waveguides 4 are provided at coupling parts between the electromagnetic wave distribution waveguide 3 and the respective electromagnetic wave radiation waveguides 4. A plurality of inductive walls 23 are provided in the electromagnetic wave distribution waveguide 3 in accordance with the respective electromagnetic wave radiation waveguides 4. As a result, as indicated by arrows in FIG. 12, an electromagnetic wave oscillated by the electromagnetic wave source 2 and propagated through the electromagnetic wave distribution waveguide 3 is substantially vertically bent and fed to the electromagnetic wave radiation waveguides 4 adjacent to each other with the same amount of power in reversed phases.

That is, as schematically shown in FIG. 15, a magnetic field direction of a wavelength of the electromagnetic wave is reversed in accordance with each half wavelength. Therefore, when the electromagnetic wave radiation waveguide cycle p is set to ½ of the guide wavelength λ_{g1} and the power feed window 21 is provided in accordance with each half wavelength, magnetic field directions of the electromagnetic wave fed to the electromagnetic wave radiation waveguides 4 adjacent to each other can be reversed each other.

Moreover, the plurality of inductive walls 23 which bulge toward each corresponding electromagnetic wave radiation waveguide 4 side are provided on a surface in the electromagnetic wave distribution waveguide 3 which faces a surface from which each electromagnetic wave radiation waveguide 4 branches. A reflection wave generated by provision of each power feed window 21 can be canceled out by a reflection wave produced by each inductive wall 23.

Additionally, in the plasma processing apparatus 1 according to this embodiment, a thickness t₁ of each electromagnetic wave radiation window 7 is set to a value which is an integral multiple of ½ of a wavelength λ_{w} of the electromagnetic wave output from the electromagnetic wave source 2 in the electromagnetic wave radiation window 7. Further, a distance t₂ between the electromagnetic wave radiation window 7 and a slot 5a facing this window is set to ⅛ or above of a free space wavelength λ₀ of the electromagnetic wave output from the electromagnetic wave source 2. It is to be noted that any other structures including non-illustrated structures are equal to those in the first embodiment, and hence like reference numerals denote corresponding parts, thereby eliminating the tautological explanation.

Since the plasma processing apparatus 1 according to this embodiment is configured to feed the same amount of power to the electromagnetic wave radiation waveguides 4 adjacent to each other in reversed phases, a change in an electromagnetic wave radiation quantity with respect to a frequency can be reduced. Further, since the resonance characteristics have single-peak properties, the slots 5 can be readily designed as an antenna. Furthermore, since the electromagnetic waves having different phases are supplied to the electromagnetic wave radiation waveguides 4 adjacent to each other, the electromagnetic wave can be suppressed from leaking between the adjacent electromagnetic wave radiation waveguides 4. Moreover, since reversed-phase power feeding is not very sensitive to a frequency of the electromagnetic wave as compared with in-phase power feeding, the apparatus can be readily designed, and the electromagnetic wave having a relative large frequency range can be used.

According to the plasma processing apparatus 1 of this embodiment, since the thickness t₁ of the electromagnetic wave radiation window 7 is set to an integral multiple of ½ of the wavelength λ_{w}, reflection of the electromagnetic wave on the surface of the electromagnetic wave radiation window 7 can be suppressed. Therefore, the electromagnetic wave can be efficiently led into the vacuum chamber 6. Additionally, since the distance t₂ between the electromagnetic wave radiation window 7 and the slot 5a facing this window is set to ⅛ or above of the free space wavelength λ₀, it is possible to suppress an influence of provision of the electromagnetic wave radiation window 7 formed of a dielectric member in the vicinity of each slot 5a on coupling of the slot 5a.

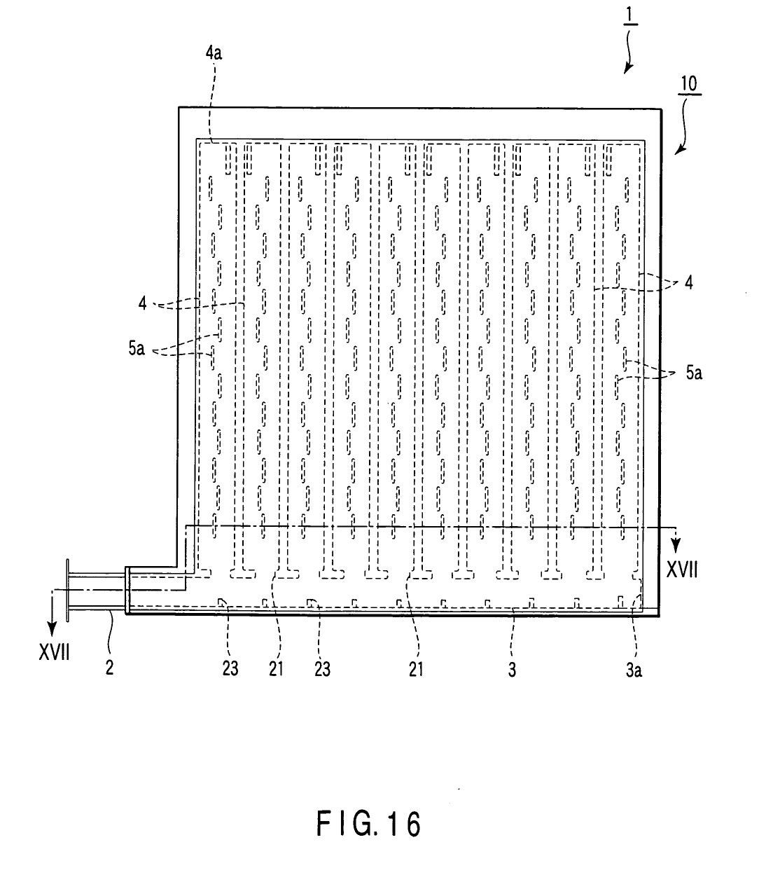

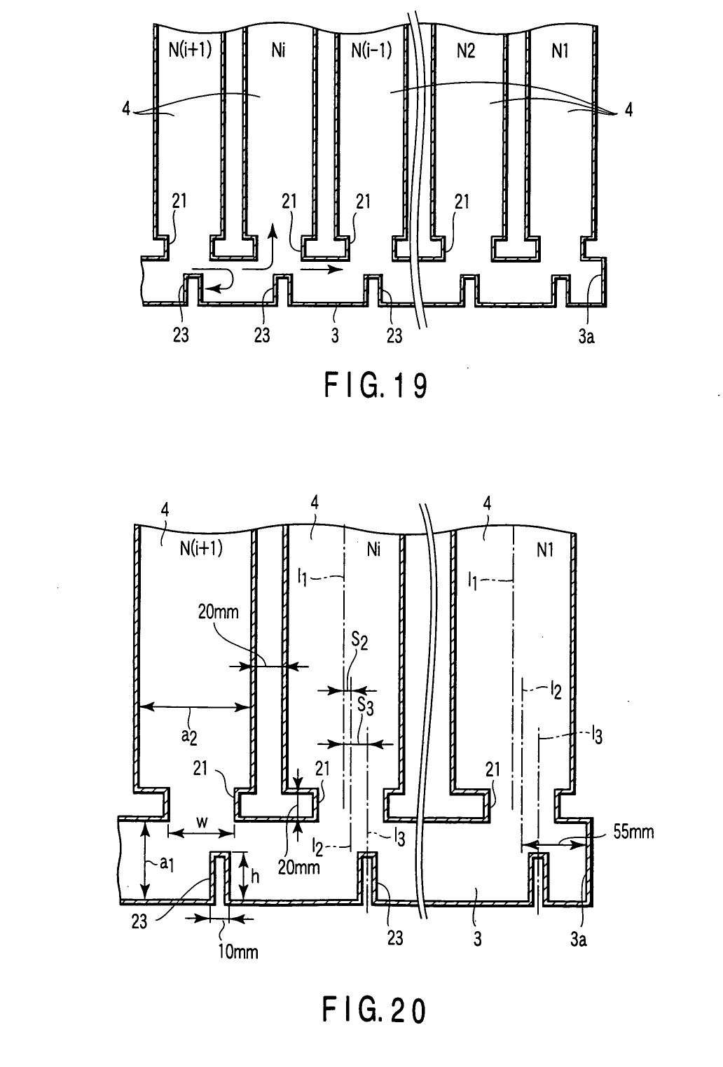

A seventh embodiment according to the present invention will now be described hereinafter with reference to FIGS. 16 to 25.

In a plasma processing apparatus 1 according to this embodiment, like the sixth embodiment, each electromagnetic wave radiation waveguide 4 is provided outside a vacuum chamber 6, and the same amount of power is fed in reversed phases to the electromagnetic wave radiation waveguides 4 adjacent to each other.

A waveguide number N will be given to each electromagnetic wave radiation waveguide 4, and a slot number M will be given to each of a plurality of slots 5a provided to each electromagnetic wave radiation waveguide 4 for better understanding. As to the waveguide number N, N=1, N=2 . . . will be given from a trailing end 3a side of an electromagnetic wave distribution waveguide 3. In regard to the slot number, M=1, M=2 . . . will be given from the electromagnetic wave distribution waveguide 3 side. Further, each parameter concerning the plasma processing apparatus 1 according to this embodiment is as shown in the following Table 2.

TABLE 2

| | | |
|---|---|---|
| Frequency λ of | 2.45 | GHz |
| electromagnetic wave source | | |
| Thickness t₃ of slot plate | 3 | mm |
| Slot gap d | 70.59 | mm |
| Slot width y (slot number | 5 | mm |
| M = 1 to 13) | | |
| Slot width Yₘ (M = 14, | 10 | mm |
| matching slot) | | |
| Distance r from trailing end | 42 | mm |
| to center of matching slot | | |

| | |
|---|---|
| Number of electromagnetic | 10 |
| wave radiation waveguides | |

Furthermore, in the plasma processing apparatus 1 according to this embodiment, each power feed window 21 is set in such a manner that one arranged closer to the electromagnetic wave propagating direction side has a larger opening width w. Moreover, each power feed window 21 arranged closer to a side opposite to the magnetic wave propagating direction side has a central axis 12 parallel with a longitudinal direction of each electromagnetic wave radiation waveguide 4 being offset toward the electromagnetic wave propagating direction side with respect to the central axis 12 along the longitudinal direction of the corresponding electromagnetic wave radiation waveguide 4.

Each inductive wall 23 arranged closer to the electromagnetic wave propagating direction side has a longer bulge length h. Additionally, each inductive wall 23 arranged closer to the electromagnetic wave propagating direction side has a central axis 13 parallel with the longitudinal direction of each electromagnetic wave radiation waveguide 4 being offset toward the electromagnetic wave propagating direction side with respect to the central axis l₂ of a corresponding power feed window 21 parallel with the longitudinal direction of the electromagnetic wave radiation waveguide 4.

An amount of offset of the central axis l₃ of the inductive wall 23 parallel with the longitudinal direction of the electromagnetic wave radiation waveguide 4 toward the electromagnetic wave propagating direction side with respect to the central axis l₂ of a corresponding power feed window 21 parallel with the longitudinal direction of the electromagnetic wave radiation waveguide 4 will be referred to as an offset amount S₃ of the inductive wall 23 hereinafter. Further, an amount of offset of the central axis 13 Of the power feed window 21 parallel with the longitudinal direction of the electromagnetic wave radiation waveguide 4 toward the electromagnetic wave propagating direction side with respect to a central axis l₁ along the longitudinal direction of a corresponding electromagnetic wave radiation waveguide 4 will be referred to as an offset amount S₂ of the power feed window 21 hereinafter.

A relationship between each electromagnetic wave radiation waveguide 4, a width w of a corresponding power feed window 21, an offset amount s₂ of the corresponding power feed window 21, a bulge length h of a corresponding inductive wall 23 and an offset amount s₃ of the corresponding inductive wall 23 is as shown in the following Table 3.

TABLE 3

| | Power feed window | | Inductive wall | |
|---|---|---|---|---|
| Waveguide | Width w | Offset s₂ | Bulge length h | Offset s₃ |
| number N | [mm] | [mm] | [mm] | [mm] |
| 1 | 70 | −5 | 30.1 | 6 |
| 2 | 61.3 | −2.6 | 25.7 | 7.3 |
| 3 | 56.9 | 1 | 22.7 | 5.1 |
| 4 | 54.5 | 3.8 | 20.9 | 4.1 |
| 5 | 53.1 | 5.8 | 19.7 | 3.3 |
| 6 | 52.1 | 7.2 | 18.9 | 2.9 |
| 7 | 51.1 | 8.6 | 18.3 | 2.5 |
| 8 | 50.4 | 9.4 | 17.8 | 2.3 |
| 9 | 49.7 | 10.2 | 17.5 | 2.1 |
| 10 | 49.1 | 11 | 17.1 | 1.9 |

It is to be noted that the width w of the power feed window 21, the offset amount s₂ of the power feed window 21, the bulge length h of the inductive wall 23 and the offset amount s₃ of the inductive wall 23 shown in Table 3 are just examples of values analyzed while taking each parameter depicted in Table 2 into consideration, and the present invention is not restricted thereto.

Furthermore, when an amount of offset of a central axis l₄ of each slot 5a parallel with the longitudinal direction of the electromagnetic wave radiation waveguide 4 toward the outside with respect to the central axis l₁ along the longitudinal direction of the electromagnetic wave radiation waveguide 4 (which will be referred to as an offset amount s₁ of the slot 5a hereinafter) is adjusted, an electromagnetic wave radiation quantity from each slot 5a can be controlled. Moreover, when a length of each slot 5a (which will be referred to as a slot length x hereinafter) is adjusted, it is possible to control a resonance state (a transmission phase is 0) to be maintained. In the plasma processing apparatus 1 according to this embodiment, the slot length x and the offset amount s₁ of the slot are adjusted as shown in Table 4.

TABLE 4

| Slot number M | Length x [mm] | Offset s₁ [mm] |
|---|---|---|
| 1 | 57.83 | 5.56 |
| 2 | 57.70 | 4.91 |
| 3 | 57.92 | 5.98 |
| 4 | 57.88 | 5.81 |
| 5 | 57.98 | 6.27 |
| 6 | 58.50 | 8.50 |
| 7 | 58.98 | 10.38 |
| 8 | 58.45 | 8.33 |
| 9 | 58.13 | 6.94 |
| 10 | 58.08 | 6.74 |
| 11 | 58.42 | 8.19 |
| 12 | 58.66 | 9.15 |
| 13 | 60.17 | 14.34 |
| 14 | 63.00 | 29.00 |
| (Matching slot) | | |

### It is to be noted that the slot length x and the offset amount s₁ shown in Table 4 are just examples of values analyzed taking each parameter of the like depicted in Table 2 into consideration, and the present invention is not restricted thereto.

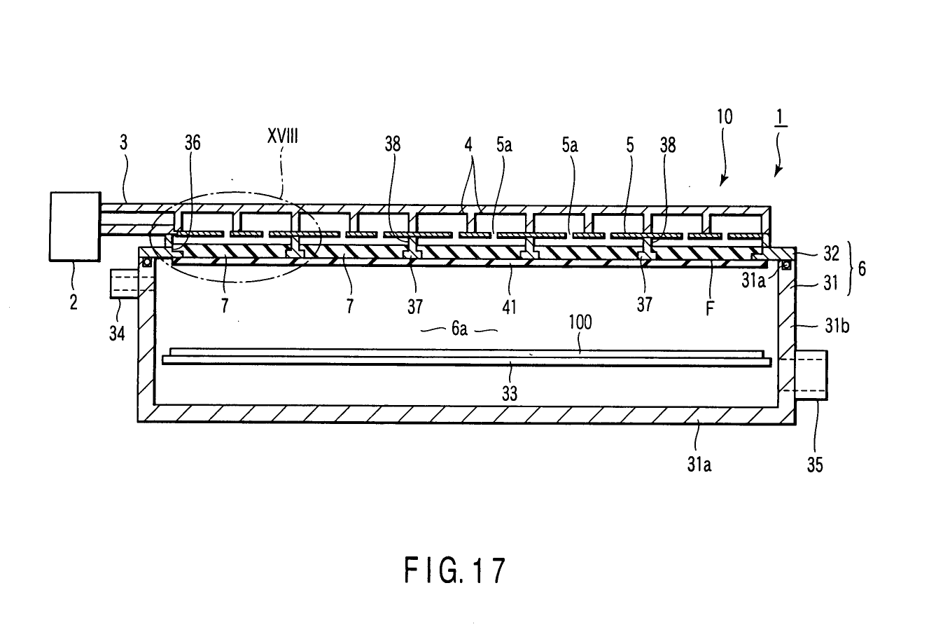

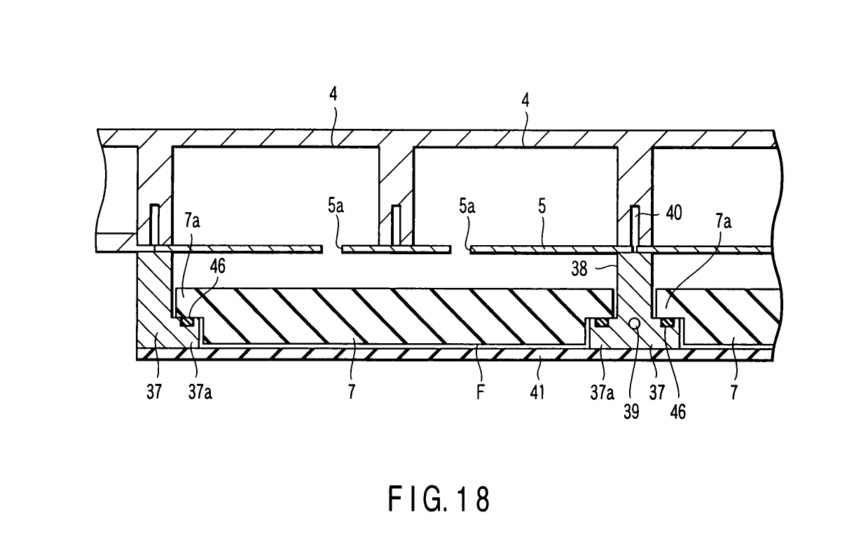

Additionally, as shown in FIGS. 17 and 18, each electromagnetic wave radiation window 7 is provided to correspond to two or more electromagnetic wave radiation waveguides 4. Further, a sealing member, e.g., an O-ring 31a is provided between each electromagnetic wave radiation window 7 and the vacuum chamber 6 in order to hold a vacuum state of the vacuum chamber 6. It is to be noted that any other structures including non-illustrated structures are the same as those in the first embodiment, and hence like reference numerals denote corresponding parts, thereby eliminating the tautological explanation.

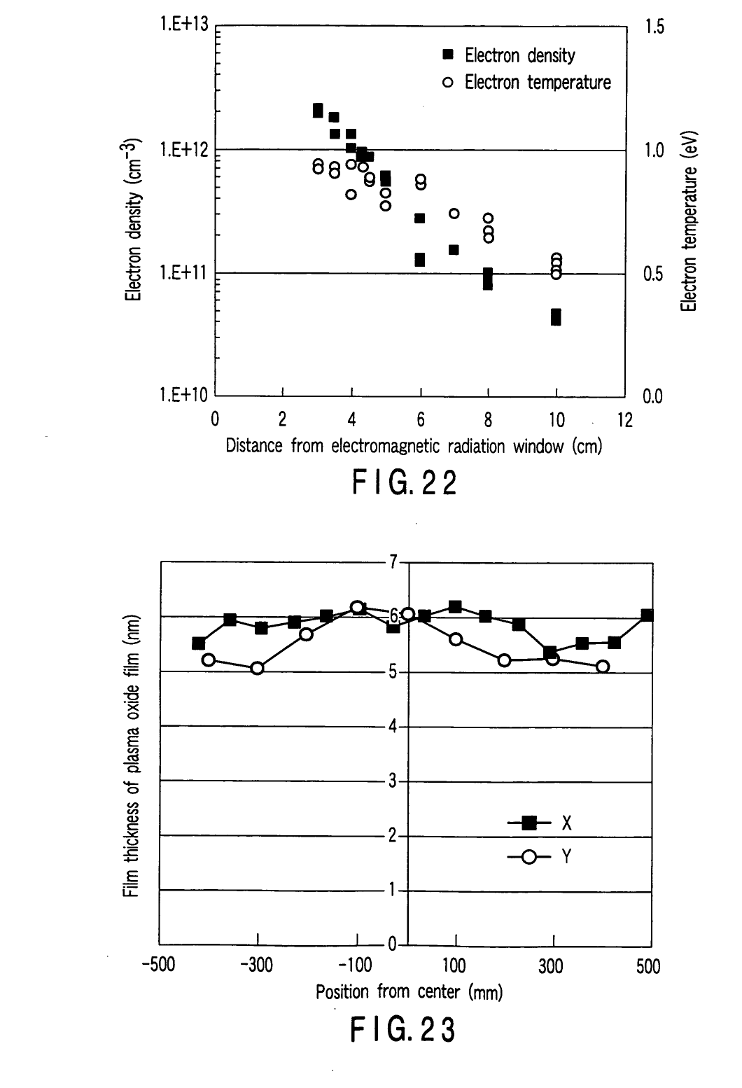

FIG. 22 shows a relationship between a distance from the electromagnetic wave radiation window 7 and an electron density/an electron temperature. As shown in FIG. 22, in the plasma processing apparatus 1 according to this embodiment, it was found that the electron density and the electron temperature can be reduced as the distance from the electromagnetic wave radiation window is increased. Therefore, in this plasma processing apparatus 1, providing a substrate to be processed 100 at a position apart from a region where an electromagnetic wave has entered by a predetermined distance can suppress an increase in an electric field of a sheath generated in the vicinity of a processing target surface of the substrate to be processed 100. Therefore, an incidence energy of an ion to the substrate to be processed 100 is lowered, whereby the ion can be suppressed from damaging the substrate to be processed 100 during plasma processing.

As described above, in the plasma processing apparatus 1 according to this embodiment, the following effects can be demonstrated. That is, a supply quantity of the electromagnetic wave can be readily reduced as a distance of the electromagnetic wave radiation waveguide 4 from the electromagnetic wave source 2 is increased. However, when the opening width w of each power feed window 21 is set to become larger as the power feed window 21 is arranged closer to the electromagnetic wave propagating direction side, the electromagnetic wave can be uniformly supplied to each electromagnetic wave radiation waveguide 4.

When the offset amount (a shift amount) S₂ of each power feed window 21 is set larger as the power feed window 21 is arranged farther from the electromagnetic wave propagating direction side, a phase shift of the electromagnetic wave can be corrected. Therefore, the electromagnetic wave radiation waveguides 4 adjacent to each other can be excellently coupled with a phase shift of 180 degrees.

When the bulge length h of each inductive wall 23 and the offset amount (the shift mount) S₃ of each inductive wall 23 are adjusted, a reflection wave controlled to have a desired amplitude and phase can be generated on the inductive wall 23. As a result, a reflection wave generated by provision of each power feed window 21 can be canceled out.

When the opening width w of each power feed window 21 is set larger as an arrangement position of the power feed window 21 is closer to the electromagnetic wave propagating direction side and the offset amount S₂ of each power feed window 21 is set larger as an arrangement position of the power feed window 21 is farther from the electromagnetic wave propagating direction side, the bulge length h of each inductive wall 23 is set larger as an arrangement position of the inductive wall 23 is closer to the electromagnetic wave propagating direction side, whereby the reflection wave controlled to cancel out the reflection wave produced by provision of the power feed window 21 can be generated on the inductive wall 23.

When the offset amount s₁ of each slot 5a is adjusted (the offset amount s₁ is set to differ depending on each slot 5a), an electromagnetic wave radiation quantity can be controlled. Additionally, when each slot length x is adjusted (the slog length x is set to differ depending on each slot), a resonance state (a transmission phase is 0) can be controlled to be maintained.

Further, each electromagnetic wave radiation window 7 is provided to correspond to two or more electromagnetic wave radiation waveguides 4. Furthermore, a sealing member, e.g., an O-ring which holds a vacuum state of the vacuum chamber 6 is provided between the electromagnetic wave radiation windows 7 and the vacuum chamber 6. Therefore, a thickness t₁ of each electromagnetic wave radiation window 7 can be reduced as compared with a case where one electromagnetic wave radiation window 7 is provided to cope with all the electromagnetic wave radiation waveguides 4. Moreover, as compared with the case where one electromagnetic wave radiation window 7 is provided to correspond to one electromagnetic wave radiation waveguide 4, the number of beams 37 which support the electromagnetic wave radiation windows 7 can be reduced, thereby improving efficiency of radiating the electromagnetic wave into the vacuum chamber 6. Therefore, plasma can be uniformly generated in the vacuum chamber 6.

A plasma processing method using the plasma processing apparatus 1 according to this embodiment will now be described while taking formation of n channel type and p channel type polycrystal silicon thin film transistors as an example.

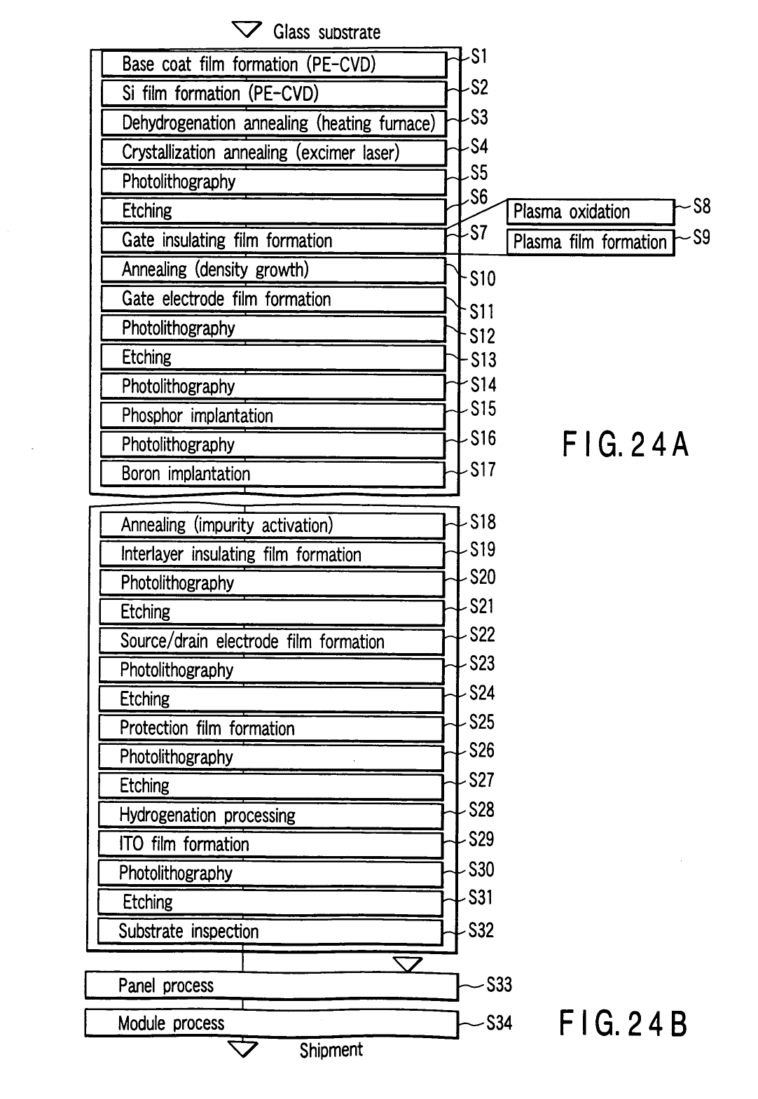

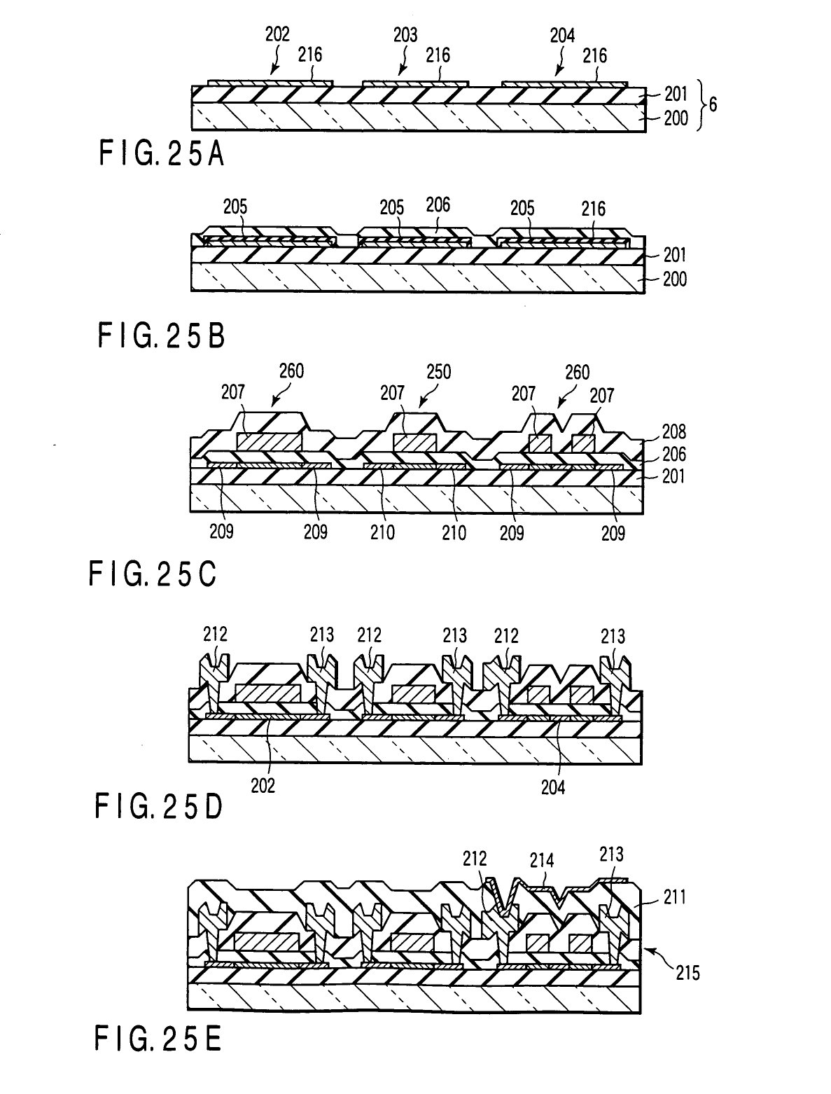

FIGS. 24A and 24B are views showing examples of flowcharts of manufacturing processes when forming n channel type and p channel type polycrystal silicon thin film transistors, and FIGS. 25A to 25E are substrate cross-sectional views in respective manufacturing steps when forming n channel type and p channel type polycrystal silicon thin film transistors.

First, a substrate 200 as the substrate to be processed 100 is prepared. As the substrate 200, it is possible to use, e.g., a glass sheet having a size of 320 mm×400 mm×1.1 mm.

As shown in FIG. 25A, a silicon oxide film (an SiO₂ film) having a thickness of 200 nm is formed as a base coat film 201 (see FIG. 25A) on the cleaned substrate 200 by a PE-CVD method (a plasma CVD method) using a TEOS gas (S1).

Then, SiH₄ and H₂ gases are used to form an amorphous silicon film having a thickness of 50 nm by the PE-CVD method (S2). This amorphous silicon film contains 5 to 15 atom % of hydrogen. Therefore, when this amorphous silicon film is directly irradiated with a laser beam, hydrogen becomes a gas, this film is suddenly subjected to cubical expansion, and the film is blown off. Therefore, the substrate 200 having the amorphous silicon film formed thereon is maintained for approximately one hour at a temperature of 350° C. or above at which coupling of hydrogen is released in order to let hydrogen out (S3).

Then, pulse light (670 mJ/pulse) having a wavelength of 308 nm from a xenon chloride (XeCl) excimer laser beam source is shaped into a size of 0.8 mm×130 mm by an optical system. The amorphous silicon film on the substrate 200 is irradiated with the laser beam with an intensity of 360 mJ/cm². Amorphous silicon absorbs the laser beam to fuse, and has a liquid phase. Then, a temperature of amorphous silicon is reduced so that amorphous silicon is solidified. As a result, polycrystal silicon can be obtained. The laser beam has a pulse of 200 Hz, and fusion and solidification are terminated within a time of one pulse. Therefore, fusion and solidification are repeated every one pulse by laser irradiation. When the laser beam is applied while moving the substrate 200, a large area can be crystallized. In order to suppress irregularities in characteristics, it is good enough to perform irradiation while overlapping 95 to 97.5% of irradiation regions of individual laser pulse beams (S4).

This polycrystal silicon layer is patterned into an island-shaped polycrystal silicon layer corresponding to a source, a channel and a drain as shown in FIG. 25A by a photolithography step (S5) and an etching step (S6), thereby forming an n channel TFT region 202, a p channel TFT region 203 and a pixel portion TFT region 204 (the steps described thus far correspond to FIG. 25A).

Thereafter, formation of a gate insulating film (S7) which is most important in a Poly-Si TFT is carried out by using the plasma processing apparatus 1 according to this embodiment. The substrate 200 having the island-shaped polycrystal silicon layer 216 on the base coat film 201 (FIG. 24A) is set on a support base 33 whose temperature is set to 350° C. Then, a gas in which an Ar gas and an oxygen gas are mixed at a ratio of Ar/(Ar+O2)=95% is introduced into the processing chamber 6a from a gas introducing opening 34, and 80 Pa is maintained. Power of 5 kW is supplied from the electromagnetic wave source 2 of 2.45 GHz so that oxygen plasma is formed to perform plasma oxidation. Since the oxygen plasma decomposes the oxygen gas into an oxygen atom active species having high reactivity, the island-shaped polycrystal silicon layer 216 is oxidized by this oxygen atom active species, thereby forming a photo-oxidized film (an SiO₂ film) as a first gate insulating film 205 (see FIG. 24B). This plasma processing apparatus 1 forms the first gate insulating film 205 at a film formation rate of forming a film thickness of approximately 3 nm in three minutes (S8).

Then, a second gate insulating film 206 consisting of an SiO₂ film is formed by the plasma CVD method. First, the oxygen gas used for the first gate insulating film 205 is discharged, and a process atmosphere used to form an SiO₂ film as the second gate insulating film 206 is continuously generated. In this example, a substrate temperature of 350° C. is maintained, a flow quantity of the TEOS gas is set to 30 sccm, a flow quantity of the oxygen gas is set to 7500 sccm, a pressure is set to 267 Pa (2 Torr), and power of 450 W is supplied from the electromagnetic wave source 2. In this processing apparatus 1, the second gate insulating film 206 having a film thickness of 30 nm is formed in two minutes (S9).

According to this plasma processing method, the film formation step (S8) of the first gate insulating film 205 by plasma oxidation and the film formation step (S9) of the second gate insulating film 206 based on the plasma CVD method having a high density/less damages can be continuously used to form the films with excellent productivity without being exposed to atmospheric air. Further, an interface between a semiconductor (the island-shaped polycrystal silicon layer 216) and the first gate insulating film 205 is excellent, and a thick practical insulating film can be rapidly formed.

Thereafter, a Poly-Si TFT is formed by the same manufacturing steps as those in the prior art. First, there is performed annealing processing in which the substrate 200 is maintained in a nitrogen gas atmosphere at a substrate temperature of 350° C. for two hours. A density of the first gate insulating film 205 formed of an SiO₂ film is increased by this annealing processing (S10). When a density of the SiO₂ film is increased, characteristics of a leak current and a withstand voltage are improved.

Then, a barrier layer formed of Ti having a film thickness of 100 nm is formed by using a sputtering technique, and then an Al film having a film thickness of 400 nm is likewise superimposed and formed (S11). As shown in FIG. 25C, patterning (etching) processing is performed (S13) with respect to a metal layer formed of this Al film by using a photolithography technology (S12), thereby forming a gate electrode 207.

Thereafter, a p channel TFT 250 alone is covered with a photoresist (not shown) in the photolithography step (S14). Then, 6×10⁵/cm² of phosphor is doped with 80 keV into an n⁺ source/drain contact portion 209 of an n channel TFT 260 by an ion doping method with the gate electrode 207 being used as a mask (S15).

Subsequently, the n channel TFT 260 in each of an n channel TFT region 202 and a pixel portion TFT region 204 is covered with the photoresist by using the photolithography technology (S16). Boron is doped into a P⁺ source/drain contact portion 210 (see FIG. 25C) at 60 keV and a concentration of 1×10¹⁶/cm² by the ion doping method with the gate electrode 207 being used as a mask (S17).

After the doping processing, the substrate 200 is subjected to annealing processing at a substrate temperature of 350° C. for two hours so that the ion-doped phosphor and boron are activated (S18). Furthermore, an interlayer insulating film 208 formed of SiO₂ is formed by the plasma CVD method using the TEOS gas (S19) (see FIG. 25(C)).

Then, each contact hole connecting to the n⁺ source/drain contact portion 209 and the P⁺ source/drain contact portion 210 is patterned as shown in FIG. 24D by the photolithography step (S20) and the etching step (S21 in FIG. 24B). Subsequently, a barrier metal (not shown) formed of Ti having a film thickness of 100 nm is formed by sputtering, then an Al layer having a film thickness of 400 nm is formed (S22). Moreover, each source electrode 213 and each drain electrode 212 are patterned by using the photolithography technology (S23) and the etching technology (S24) (see FIG. 25D).

Additionally, as shown in FIG. 25E, the plasma CVD technology is used to form a protection film 211 formed of an SiO₂ film having a film thickness of 300 nm (S25). Further, a connection contact hole with respect to a pixel electrode 214 (which will be described later) formed of ITO is patterned and formed by using the photolithography technology (S26) and the etching technology (S27) in such a manner that each drain electrode 212 of the n channel TFT 260 (see FIG. 25C) in the pixel portion TFT region 204 (see FIG. 25A) is exposed.

Thereafter, a gas having a mixed ratio of a nitrogen gas flow quantity: a hydrogen gas flow quantity=97:3 is allowed to flow into a hydrogen annealing furnace under a substantially atmospheric pressure, and processing is carried out for 80 minutes at a substrate temperature of 400° C. When the hydrogen plasma processing is eliminated, processing must be performed for one hour under the same conditions as described above.

Then, the substrate is moved into another reactive chamber to form ITO having a thickness of 150 nm (S29). The ITO is patterned by using the photolithography technology (S30) and the etching technology (S31), thereby forming a pixel electrode 214. As a result, a TFT substrate 215 is brought to completion (see FIG. 25E). Subsequently, a substrate inspection is carried out (S32).

Polyimide is applied to this TFT substrate 215 and a glass substrate (not shown) having a color filter (not shown) formed thereon, these substrates are rubbed, and then they are attached to each other. Thereafter, the attached substrates are divided into respective panels.

These panels are put into a vacuum tank, an inlet of each panel is soaked in liquid crystal put in a bowl, and air is introduced into the tank. As a result, liquid crystal is filled into each panel with a pressure of air. Subsequently, the inlet is sealed by using a resin, thereby bringing a liquid crystal panel to completion (S33).

Then, a deflection plate is attached, and a peripheral circuit, a backlight, a bezel and others are disposed, whereby a liquid crystal module comes to completion (S34).

This liquid crystal module can be used for a personal computer, a monitor, a television, a portable terminal and others. When a plasma oxide film is not provided and an SiO₂ film is formed by the regular plasma CVD method like the prior art, a threshold voltage of the TFT is 1.9 V±0.8 V. However, when plasma processing is carried out by the plasma processing apparatus 1 according to this embodiment as described above, the threshold voltage of the TFT was improved to 1.5 V±0.6 V by improvement in interface characteristics of the silicon oxide film and polycrystal silicon (the island-shaped polycrystal silicon layer 216) and in insulating film bulk characteristics. Moreover, since irregularities in threshold voltage were reduced, a fair quality ratio was greatly increased. Additionally, according to the laminated configuration of the plasma oxide film and the plasma CVD film having a high density/less damages, a coverage is improved and characteristics of the CVD film become excellent. Therefore, a film quality of the gate insulating film can be reduced to approximately ⅓, i.e., 30 nm from 80 to 100 nm in the prior art, thus tripling an on current.

As described above, according to the plasma processing method of this embodiment, since the above-mentioned plasma processing apparatus 1 is used, the substrate as the substrate to be processed 100 can be excellently subjected to plasma oxidation, and plasma film formation can be satisfactorily effected. It is to be noted that the substrate as the substrate to be processed 100 can be subjected to plasma etching by using the plasma processing apparatus 1 according to this embodiment.

It is to be noted that the plasma processing method according to this embodiment can excellently perform plasma oxidation with respect to the substrate as the substrate to be processed 100 by using not only the plasma processing apparatus 1 described in conjunction with the seventh embodiment but also the plasma processing apparatus 1 described in each of the first to sixth embodiments, and also excellently carry out plasma film formation. Moreover, the substrate as the substrate to be processed 100 can be subjected to plasma etching by using any of the plasma processing apparatuses 1 according to the first to sixth embodiments.

Although the above has described the embodiments, this specification includes an invention of a plasma processing method characterized by performing plasma oxidation, plasma film formation or plasma etching with respect to a substrate to be processed by using the plasma processing apparatus according to the present invention. According to this plasma processing method, effecting plasma processing (plasma oxidation, plasma film formation or plasma etching) with respect to a substrate to be processed can uniformly perform plasma processing with respect to this substrate to be processed irrespective of a shape or a size of the substrate to be processed.

Additionally, the above-described embodiments include the following invention, functions and effects.

[1] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which branch from an electric field surface or a magnetic field surface of this electromagnetic wave distribution waveguide in a vertical direction, and are aligned and provided in parallel; a plurality of slots which are provided to each of these electromagnetic wave radiation waveguides and constitute a waveguide antenna; and a processing chamber into which the electromagnetic wave radiated from the slots enters, the plasma processing apparatus generating plasma by using the electromagnetic wave which has entered the processing chamber from the slots, thereby performing plasma processing based on this plasma, wherein when a guide wavelength λ_{g1} of the electromagnetic wave output from the electromagnetic wave source in the electromagnetic wave distribution waveguide is set as follows:

λ_{g1}=λ₀/{square root over (εᵣ₁−(λ₀/(2a₁))²)} (1)

a width a₂ of the electromagnetic wave radiation waveguide, a height b₂ of the electromagnetic wave radiation waveguide and a cycle p in which the electromagnetic wave radiation waveguides are aligned satisfy the following relationship:

λ₀>p>a₂>b₂ (2)

where λ₀ is a free space wavelength of the electromagnetic wave output from the electromagnetic wave source, a₁ is a width of the electromagnetic wave distribution waveguide, and εᵣ₁ is a specific inductive capacity of a dielectric material in the electromagnetic wave distribution waveguide.

It is to be noted that the width a₁ in the electromagnetic wave distribution waveguide means a width of an inner shape of the electromagnetic wave distribution waveguide. The width a₂ in the electromagnetic wave radiation waveguide means a width of an inner shape of each electromagnetic wave radiation waveguide. The height b₂ in the electromagnetic wave radiation waveguide means a height of the inner shape of each electromagnetic wave radiation waveguide.

According to the plasma processing apparatus described in claim 1 of the present invention, the plurality of electromagnetic eave radiation waveguides aligned and provided in parallel are configured to branch in the vertical direction from the electric field surface or the magnetic field surface of the electromagnetic wave distribution waveguide through which the electromagnetic wave output from the electromagnetic wave source is propagated. Further, the plurality of slots constituting the waveguide antenna are provided in each electromagnetic wave radiation waveguide. Therefore, a substrate to be processed can be uniformly subjected to plasma processing irrespective of a size or a shape of this substrate to be processed to which the plasma processing is performed. Furthermore, a compact plasma processing apparatus having a small apparatus footprint and a low apparatus height can be obtained.

Moreover, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Additionally, the electromagnetic wave can be supplied to the plurality of electromagnetic wave radiation waveguides from one electromagnetic wave source through the electromagnetic wave distribution waveguide. Accordingly, the electromagnetic wave having the same frequency can be supplied to the respective electromagnetic wave radiation waveguides, and hence a waveguide antenna which can uniformly radiate the electromagnetic wave can be readily designed.

Further, since the electromagnetic wave radiation waveguide cycle p is set to be less than the free space wavelength λ₀ of the electromagnetic wave, occurrence of a side lobe (deterioration in directivity) which is a so-called grating lobe can be suppressed.

[2] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which branch from an electric field surface or a magnetic field surface of this electromagnetic wave distribution waveguide in a vertical direction and are aligned and arranged in parallel; a plurality of slots which are provided to each of these electromagnetic wave radiation waveguides and constitute a waveguide antenna; and a processing chamber into which the electromagnetic wave radiated from the slots enters, the plasma processing apparatus generating plasma by using the electromagnetic wave which has entered the processing chamber from the slots, thereby performing plasma processing based on this plasma, wherein when a guide wavelength λ_{g1} of the electromagnetic wave output from the electromagnetic wave source in the electromagnetic wave distribution waveguide has a value represented by the above Expression (1), a width a₂ of the electromagnetic wave radiation waveguide, a height b₂ of the electromagnetic wave radiation waveguide and a cycle p in which the electromagnetic wave radiation waveguides are aligned satisfy the above Expression (2) and also satisfy the following relationship:

p=(λ_{g1}/2)±α (where α is 5% or below of λ_{g1}) (3-1)

where λ₀ is a free space wavelength of the electromagnetic wave output from the electromagnetic wave source, a₁ is a width of the electromagnetic wave distribution waveguide, and εᵣ₁ is a specific inductive capacity of a dielectric material in the electromagnetic wave distribution waveguide.

According to the plasma processing apparatus described in claim 2 of the present invention, the plurality of electromagnetic wave radiation waveguides aligned and provided in parallel are configured to branch in the vertical direction from the electric field surface or the magnetic field surface of the electromagnetic wave distribution waveguide through which the electromagnetic wave output from the electromagnetic wave source is propagated. Further, the plurality of slots constituting the waveguide antenna are provided in each electromagnetic wave radiation waveguide. Therefore, a substrate to be processed can be uniformly subjected to plasma processing irrespective of a size or a shape of this substrate to be processed to which the plasma processing is performed. Furthermore, it is possible to obtain a compact plasma processing apparatus having a small apparatus footprint and a low apparatus height.

Moreover, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Additionally, the electromagnetic wave can be supplied to the plurality of electromagnetic wave radiation waveguides from one electromagnetic wave source through the electromagnetic wave distribution waveguide. Accordingly, the electromagnetic wave having the same frequency can be supplied to the respective electromagnetic wave radiation waveguides, and hence a waveguide antenna capable of uniformly radiating the electromagnetic wave can be readily designed.

Further, since the electromagnetic wave radiation waveguide cycle p is set to be less than the free space wavelength λ₀ of the electromagnetic wave, occurrence of a side lobe (deterioration in directivity) which is a so-called a grating lobe can be suppressed.

Furthermore, when the electromagnetic wave radiation waveguide cycle p is set to approximately ½ of the guide wavelength λ_{g1} of the electromagnetic wave in the electromagnetic wave distribution waveguide, each electromagnetic wave radiation waveguide can be arranged at a position where an amplitude of a wavelength of the electromagnetic wave always becomes constant. Therefore, supply of power to each electromagnetic wave radiation waveguide can be easily adjusted.

It is to be noted that “the electromagnetic wave radiation waveguide cycle p is approximately ½ of the guide wavelength λ_{g1} of the electromagnetic wave in the electromagnetic wave distribution waveguide” means that p=λ_{g1}/2 is achieved and its error is 5% or below of λ_{g1}, namely, the electromagnetic wave radiation waveguide cycle p is set to satisfy the following expression:

(λ_{g1}/2)−0.05λ_{g1}≦p≦(λ_{g1}/2)+0.05λ_{g1} (3-2)

[3] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which are provided to branch from this electromagnetic wave distribution waveguide; a plurality of slots which are aligned and arranged in each electromagnetic wave radiation waveguide along an electromagnetic wave propagating direction and constitute a waveguide antenna; and a processing chamber into which the electromagnetic wave radiated from the slots enters, the plasma processing apparatus generating plasma by using the electromagnetic wave which has entered the processing chamber from the slots, thereby performing plasma processing based on this plasma, wherein a gap d between the slots which are adjacent to each other along the electromagnetic wave propagating direction is set to satisfy the following relationship:

λ₀>d (4)

where λ₀ is a free space wavelength of the electromagnetic wave output from the electromagnetic wave source.

According to the plasma processing apparatus described in claim 3 of the present invention, the plurality of electromagnetic wave radiation waveguides are configured to branch from the electromagnetic wave distribution waveguide through which the electromagnetic wave output from the electromagnetic wave source is propagated. Moreover, the plurality of slots constituting the waveguide antenna are aligned and arranged in each electromagnetic wave radiation waveguide along the electromagnetic wave propagating direction. Therefore, a substrate to be processed can be uniformly subjected to plasma processing irrespective of a size or a shape of this substrate to be processed to which the plasma processing is effected. Additionally, it is possible to obtain a compact plasma processing apparatus having a small apparatus footprint and a low apparatus height.

Further, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Furthermore, the electromagnetic wave can be supplied to the plurality of electromagnetic wave radiation waveguides from one electromagnetic wave source through the electromagnetic wave distribution waveguide. Therefore, since the electromagnetic wave having the same frequency can be supplied to the respective electromagnetic wave radiation waveguides, a waveguide antenna capable of radiating the uniform electromagnetic wave can be easily designed.

Moreover, like the above-described Expression (4), the gap d (which will be simply referred to as a slot gap d hereinafter) between the slots which are adjacent to each other along the electromagnetic wave propagating direction is set to be less than the free space wavelength λ₀ of the electromagnetic wave output from the electromagnetic wave source, thereby suppressing occurrence of a side lobe (deterioration in directivity) which is a so-called a grating lobe.

Incidentally, when the specific inductive capacity εᵣ₁ of the dielectric material in the electromagnetic wave distribution waveguide is approximately 1, i.e., when the electromagnetic wave distribution waveguide is hollow and filled with air, in order to suppress the slots adjacent to each other from interfering with each other, it is preferable to set the slot gap d to satisfy the following expression:

d>λ₀/2 (5)

However, when the specific inductive capacity of the dielectric material in the electromagnetic wave distribution waveguide is not smaller than 1, e.g., when the electromagnetic wave distribution waveguide is filled with the dielectric member, trying suppressing the slots adjacent to each other from interfering with each other may cause the slot gap d to deviate from Expression (5). In such a case, the slot gap d does not have to be necessarily set to satisfy Expression (5).

More preferably, when the following expression is achieved:

λ_{g2}=λ₀/{square root over (εᵣ₂−(λ₀/(2a₂))²)} (6)

it is good enough to set the slot gap d to satisfy the following expression:

d=λ_{g2}/2 (7)

where εᵣ₂ is a specific inductive capacity of the dielectric material in the electromagnetic wave radiation waveguide, and λ_{g2} is a guide wavelength of the electromagnetic wave output from the electromagnetic wave source in the electromagnetic wave radiation waveguide. When the slot gap d is set in this manner, each slot can be arranged at a position where an amplitude of the wavelength of the electromagnetic wave always becomes constant. That is, the electromagnetic wave can be radiated into the processing chamber at a position where the amplitude of the wavelength of the electromagnetic wave always becomes constant.

[4] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which branch from an electric field surface or a magnetic field surface of this electromagnetic wave distribution waveguide in a vertical direction and are aligned and provided in parallel; a plurality of slots which are aligned and arranged in each electromagnetic wave radiation waveguide along an electromagnetic wave propagating direction and constitute a waveguide antenna; and a processing chamber into which the electromagnetic wave radiated from the slots enters, the plasma processing apparatus generating plasma by using the electromagnetic wave which has entered the processing chamber from the slots, thereby effecting plasma processing based on this plasma, wherein, when a guide wavelength λ_{g1} of the electromagnetic wave output from the electromagnetic wave source in the electromagnetic wave distribution waveguide is a value represented by Expression (1), a width a₂ of the electromagnetic wave radiation waveguide, a height b₂ of the electromagnetic wave radiation waveguide and a cycle p in which the electromagnetic wave radiation waveguides are aligned are set to satisfy Expression (2) and Expression (3-1) mentioned above where λ₀ is a free space wavelength of the electromagnetic wave output from the electromagnetic wave source, a₁ is a width of the electromagnetic wave distribution waveguide, and εᵣ₁ is a specific inductive capacity of a dielectric material in the electromagnetic wave distribution waveguide, and a gap d of the slots adjacent to each other along the electromagnetic wave propagating direction is set to satisfy Expression (4) where λ₀ is a free space wavelength of the electromagnetic wave output from the electromagnetic wave source.

According to the plasma processing apparatus of the present invention, the plurality of electromagnetic wave radiation waveguides which are aligned and provided in parallel are configured to branch in the vertical direction from the electric field surface or the magnetic field surface of the electromagnetic wave distribution waveguide through which the electromagnetic wave output from the electromagnetic wave source is propagated. Furthermore, the plurality of slots constituting the waveguide antenna are aligned and arranged in each electromagnetic wave radiation waveguide along the electromagnetic wave propagating direction. Therefore, a substrate to be processed can be uniformly plasma-processed irrespective of a size or a shape of this substrate to be processed to which the plasma processing is performed. Moreover, it is possible to obtain a compact plasma processing apparatus having a small apparatus footprint and a low apparatus height.

Additionally, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Further, the electromagnetic wave can be supplied to the plurality of electromagnetic wave radiation waveguides from one electromagnetic wave source through the electromagnetic wave distribution waveguide. Therefore, since the electromagnetic wave having the same frequency can be supplied to the respective electromagnetic wave radiation waveguides, a waveguide antenna capable of radiating the uniform electromagnetic wave can be easily designed.

Furthermore, since the electromagnetic wave radiation waveguide cycle p is set to be less than the free space wavelength λ₀ of the electromagnetic wave, occurrence of a side lobe (deterioration in directivity) which is a so-called a grating lobe can be suppressed.

Moreover, when the electromagnetic wave radiation waveguide cycle p is set to approximately ½ of the guide wavelength λ_{g1} of the electromagnetic wave in the electromagnetic wave distribution waveguide, each electromagnetic wave radiation waveguide can be arranged at a position where an amplitude of the frequency of the electromagnetic wave always becomes constant. Therefore, supply of power to each electromagnetic wave radiation waveguide can be readily adjusted.

It is to be noted that “the electromagnetic wave radiation waveguide cycle p is approximately ½ of the guide wavelength λ_{g1} of the electromagnetic wave in the electromagnetic wave distribution waveguide” means that p=λ_{g1}/2 is achieved and its error is 5% or below of λ_{g1} like Expression (3-1) mentioned above, namely, the electromagnetic wave radiation waveguide cycle p is set to satisfy Expression (3-2).

Additionally, like Expression (4), since the slot gap d is set to be less than the free space wavelength λ₀ of the electromagnetic wave, occurrence of a side lobe (deterioration in directivity) which is a so-called grating lobe can be suppressed.

Incidentally, when the specific inductive capacity εᵣ₁ of the dielectric material in the electromagnetic wave distribution waveguide is approximately 1, i.e., when the electromagnetic wave distribution waveguide is hollow and filled with air, it is preferable to set the slot gap d to satisfy Expression (5) in order to suppress the slots adjacent to each other from interfering with each other. However, when the specific inductive capacity εᵣ₁ of the dielectric material in the electromagnetic wave distribution waveguide is not smaller than 1, e.g., when the electromagnetic wave distribution waveguide is filled with the dielectric member, trying suppressing the slots adjacent to each other from interfering with each other may cause the slot gap d to deviate from Expression (5). In such a case, the slot gap d does not have to be necessarily set to satisfy Expression (5).

More preferably, it is good enough to set the slot gap d to satisfy Expression (7). When the slot gap d is set in this manner, each slot can be arranged at a position where an amplitude of the wavelength of the electromagnetic wave always becomes constant. That is, the electromagnetic wave can be radiated into the processing chamber at a position where the amplitude of the wavelength of the electromagnetic wave always becomes constant.

Meanwhile, in the above-described plasma processing apparatus, an excessive electromagnetic wave which has not been distributed through each slot of each electromagnetic wave radiation waveguide is reflected at an electromagnetic wave radiation waveguide trailing end, and interferes with an electromagnetic wave propagated through the electromagnetic wave radiation waveguides toward the trailing end side so that this electromagnetic wave is disturbed. That is, in the above-described plasma processing apparatus, it is not preferable that the excessive electromagnetic wave which has not been distributed through each slot of each electromagnetic wave radiation waveguide reaches the trailing end of the electromagnetic wave radiation waveguide.

[5] In the plasma processing apparatus according to the present invention, preferably, of the plurality of slots provided to each electromagnetic wave radiation waveguide, a slot provided at the farthest position from the electromagnetic wave distribution waveguide is set to have an area larger than those of the other slots, and a distance between a central position of the slot provided at the farthest position from the electromagnetic wave distribution waveguide and a trailing end of the electromagnetic wave radiation waveguide to which this slot is provided is set to ¼ of the guide wavelength λ_{g2} of the electromagnetic wave output from the electromagnetic wave source in the electromagnetic wave radiation waveguides.

When the area of the slot (a matching slot, which will be referred to as a matching slot hereinafter) provided at the farthest position from the electromagnetic wave distribution waveguide of the plurality of slots provided to each electromagnetic wave radiation waveguide is set to be larger than areas of any other slots in this manner, the excessive electromagnetic wave which has not been distributed through each slot of the electromagnetic wave radiation waveguides can be excellently radiated into the processing chamber through the matching slot. Therefore, it is possible to suppress an influence of the electromagnetic wave (a reflection wave) reflected at the electromagnetic wave radiation waveguide trailing end.

Moreover, when the distance between the central position of the matching slot and the trailing end of the electromagnetic wave radiation waveguide to which this matching slot is provided is set to ¼ of the guide wavelength λ_{g2} of the electromagnetic wave output from the electromagnetic wave source in the electromagnetic wave radiation waveguides, it is possible to suppress an influence of the electromagnetic wave (a reflection wave) which has not been radiated into the processing chamber through the matching slot and is reflected at the electromagnetic wave radiation waveguide trailing end.

However, when the height b₂ of each electromagnetic wave radiation waveguide exceeds ½ of the width a₂ of each electromagnetic wave radiation waveguide, it has been analytically known that a design for radiating substantially 100% of incident power into the processing chamber is very difficult even if a parameter of the matching slot is changed in any way.

[6] Like the plasma processing apparatus according to the present invention, when the above-described matchihg slot is provided to the electromagnetic wave radiation waveguide, it is preferable to set the height b₂ of the electromagnetic wave radiation waveguide to ½ or below of the width a₂ of the electromagnetic wave radiation waveguide. When the height is set in this manner, setting a parameter of the matching slot to a predetermined value allows substantially 100% of incident power to be radiated into the processing chamber.

[7] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which are provided to branch from this electromagnetic wave distribution waveguide; a plurality of slots which are aligned and arranged in each electromagnetic wave radiation waveguide along an electromagnetic wave propagating direction and constitute a waveguide antenna; an electromagnetic wave radiation window which is provided to face these slots and formed of a dielectric material; and a processing chamber into which the electromagnetic wave radiated from the slots enters through the electromagnetic wave radiation window, the plasma processing apparatus generating plasma by using the electromagnetic wave which has entered the processing chamber, thereby performing plasma processing based on this plasma, wherein a thickness t₁ of the electromagnetic wave radiation window is set to an integral multiple of ½ of a wavelength λ_{W} of the electromagnetic wave output from the electromagnetic wave source in the electromagnetic wave radiation window.

According to this plasma processing apparatus, the plurality of electromagnetic wave radiation waveguides are configured to branch from the electromagnetic wave distribution waveguide through which the electromagnetic wave output from the electromagnetic wave source is propagated. Moreover, the plurality of slots constituting the waveguide antenna are aligned and arranged in each electromagnetic wave radiation waveguide along the electromagnetic wave propagating direction. Therefore, a substrate to be processed can be uniformly plasma-processed irrespective of a size or a shape of this substrate to be processed to which the plasma processing is performed. Additionally, it is possible to obtain a compact plasma processing apparatus having a small apparatus footprint and a low apparatus height.

Further, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Furthermore, the electromagnetic wave can be supplied to the plurality of electromagnetic wave radiation waveguides from one electromagnetic wave source through the electromagnetic wave distribution waveguide. Therefore, the electromagnetic wave having the same frequency can be supplied to the respective electromagnetic wave radiation waveguides, and hence a waveguide antenna capable of radiating the uniform electromagnetic wave can be readily designed.

Moreover, since the thickness t₁ of the electromagnetic wave radiation window is set to an integral multiple of ½ of the wavelength λ_{W} of the electromagnetic wave output from the electromagnetic wave source in the electromagnetic wave radiation window, reflection of the electromagnetic wave on the surface of this electromagnetic wave radiation window can be suppressed. Therefore, the electromagnetic wave can be efficiently led into the processing chamber.

Meanwhile, when a distance between the electromagnetic wave radiation window formed of a dielectric material and the slots is short, the electromagnetic wave radiation window is apt to affect coupling of the slots.

[8] In the plasma processing apparatus according to the present invention, it is preferable to set a distance t₂ between the electromagnetic wave radiation window and the slots facing this window to ⅛ or above of a free space wavelength λ₀ of the wavelength output from the electromagnetic wave source. As a result, it is possible to suppress an influence on coupling of the slots due to a fact that the electromagnetic wave radiation window formed of a dielectric member is placed in the vicinity of the slots.

[9] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which branch from an electric field surface or a magnetic field surface of this electromagnetic wave distribution waveguide in a vertical direction, and are aligned and provided in parallel; a plurality of slots which are provided to each of these electromagnetic wave radiation waveguides and constitute a waveguide antenna; and a processing chamber into which the electromagnetic wave radiated from the slots enters, the plasma processing apparatus generating plasma by using the electromagnetic wave which has entered the processing chamber from the slots, thereby effecting plasma processing based on this plasma, wherein the same amount of power is fed in phase to each electromagnetic wave radiation waveguide through Π junction.

According to this plasma processing apparatus, the plurality of electromagnetic wave radiation waveguides aligned and provided in parallel are configured to branch in the vertical direction from the electric field surface or the magnetic field surface of the electromagnetic wave distribution waveguide through which the electromagnetic wave output from the electromagnetic wave source is propagated. Further, the plurality of slots constituting the waveguide antenna are provided to each electromagnetic wave radiation waveguide. Therefore, a substrate to be processed can be uniformly plasma-processed irrespective of a size or a shape of this substrate to be processed to which the plasma processing is performed. Furthermore, it is possible to obtain a compact plasma processing apparatus having a small apparatus footprint and a low apparatus height.

Moreover, each waveguide does not have a central conductor which can be a factor of a propagation loss of the electromagnetic wave as different from a coaxial tube, and hence the electromagnetic wave can be propagated with a small propagation loss of the electromagnetic wave and large power. Accordingly, even the plasma processing apparatus which propagates the electromagnetic wave with large power can be readily designed.

Additionally, the electromagnetic wave can be supplied to the plurality of electromagnetic wave radiation waveguides from one electromagnetic wave source through the electromagnetic wave distribution waveguide. Therefore, the electromagnetic wave having the same frequency can be supplied to the respective electromagnetic wave radiation waveguides, thereby readily designing a waveguide antenna capable of radiating the uniform electromagnetic wave.

Further, this plasma processing apparatus is configured to feed the same amount of power in phase to the respective electromagnetic wave radiation waveguides through Π junction. When such a configuration is adopted, the number of branching positions of the electromagnetic wave distribution waveguide and the respective electromagnetic wave radiation waveguides can be reduced to ½ of the number of the electromagnetic wave radiation waveguides. Therefore, the configuration of the electromagnetic wave distribution waveguide can be simplified.

[10] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides which branch from an electric field surface or a magnetic field surface of this electromagnetic wave distribution waveguide in a vertical direction, and are aligned and provided in parallel; a plurality of slots provided to each of these electromagnetic wave radiation waveguides and constitute a waveguide antenna; and a processing chamber into which the electromagnetic wave radiated from the slots enters, the plasma processing apparatus generating plasma by using the electromagnetic wave which has entered the processing chamber from the slots, thereby effecting plasma processing based on this plasma, wherein the same amount of power is fed in reversed phases to the electromagnetic wave radiation waveguides which are adjacent to each other.

According to this plasma processing apparatus, the plurality of electromagnetic wave radiation waveguides aligned and provided in parallel are configured to branch in the vertical direction from the electric field surface or the magnetic field surface of the electromagnetic wave distribution waveguide through which the electromagnetic wave output from the electromagnetic wave source is propagated. Further, the plurality of slots constituting the waveguide antenna are provided to each electromagnetic wave radiation waveguide. Therefore, a substrate to be processed can be uniformly plasma-processed irrespective of a size or a shape of this substrate to be processed to which the plasma processing is effected. Furthermore, it is possible to obtain a compact plasma processing apparatus having a small apparatus footprint and a low apparatus height.

Moreover, each waveguide does not have a central conductor which can be a factor of a propagation loss of the electromagnetic wave like a coaxial tube, and hence the electromagnetic wave can be propagated with a small propagation loss of the electromagnetic wave and large power. Therefore, even the plasma processing apparatus which propagates the electromagnetic wave with large power can be readily designed.

Additionally, the electromagnetic wave can be supplied to the plurality of electromagnetic wave radiation waveguides from one electromagnetic wave source through the electromagnetic wave distribution waveguide. Therefore, since the electromagnetic wave having the same frequency can be supplied to the respective electromagnetic wave radiation waveguides, a waveguide antenna capable of radiating the uniform electromagnetic wave can be readily designed.

Further, this plasma processing apparatus is configured to feed the same amount of power in reversed phases to the electromagnetic wave radiation waveguides adjacent to each other. When such a configuration is adopted, a change in an electromagnetic wave radiation quantity with respect to a frequency can be reduced. Furthermore, resonance characteristics have single-peak properties, whereby the slots as an antenna can be easily designed. Moreover, the electromagnetic waves having different phases are supplied to the electromagnetic wave radiation waveguides adjacent to each other, thereby suppressing leak of the electromagnetic wave between the electromagnetic wave radiation waveguides adjacent to each other. Additionally, since phase power feeding is not very sensitive to a frequency of the electromagnetic wave as compared with in-phase power feeding, the apparatus can be readily designed, and the electromagnetic wave having a relative large frequency range can be used.

It is to be noted that, when the same amount of power is fed in reversed phases to the electromagnetic wave radiation waveguides adjacent to each other, this power feeding can be realized by designing the apparatus in such a manner that the electromagnetic wave is distributed to the electromagnetic wave radiation waveguides from the electromagnetic wave distribution waveguide through T junction.

[11] In the plasma processing apparatus according to the present invention, in case of feeding the same amount of power in reversed phases to the electromagnetic wave radiation waveguides adjacent to each other, it is good enough to design the apparatus in such a manner that a cycle p in which the electromagnetic wave radiation waveguides are aligned is set to ½ of a guide wavelength λ_{g1} of the electromagnetic wave output from the electromagnetic wave source in the electromagnetic wave distribution waveguide, a plurality of power feed windows which allow the electromagnetic wave distribution waveguide to communicate with each electromagnetic wave radiation waveguide are provided at coupling parts between electromagnetic wave distribution waveguide and the respective electromagnetic wave radiation waveguides and a plurality of inductive walls are provided in the electromagnetic wave distribution waveguide in accordance with the respective electromagnetic wave radiation waveguides, thereby feeding the same amount of power in reversed phases to the electromagnetic wave radiation waveguides adjacent to each other. When such a configuration is adopted, the same amount of power can be fed in reversed phases to the electromagnetic wave radiation waveguides adjacent to each other.

When each of the plurality of power feed windows which allow the electromagnetic wave distribution waveguide to communicate with the respective electromagnetic wave radiation waveguides is provided at a coupling part (a branching position) of the electromagnetic wave distribution waveguide and each electromagnetic wave radiation waveguide, this plasma processing apparatus can control a coupling quantity of the electromagnetic wave distribution waveguide and each electromagnetic wave radiation waveguide by adjusting a size of each of these power feed windows.

Additionally, since the plurality of inductive walls are provided in the electromagnetic wave distribution waveguide in accordance with the respective electromagnetic wave radiation waveguides, a reflection wave generated by provision of the power feed windows can be canceled out by a reflection wave produced by the inductive walls.

[12] In the plasma processing apparatus according to the present invention, when the same amount of power is fed in reversed phases to the electromagnetic wave radiation waveguides adjacent to each other, it is good enough to provide the plurality of inductive walls on a surface facing a surface on which the electromagnetic wave radiation waveguides branch in such a manner that the inductive walls bulge toward the respective corresponding electromagnetic wave radiation waveguides, and to set a bulge length h of each inductive wall to be longer as a distance between the inductive wall and the electromagnetic wave propagating direction side becomes shorter. Further, it is good enough to set each inductive wall in such a manner that its central axis parallel with a longitudinal direction of the electromagnetic wave radiation waveguide is offset toward the electromagnetic wave propagating direction side with respect to a central axis of a corresponding power feed window parallel with the longitudinal direction of the electromagnetic wave radiation waveguide as a distance between the inductive wall and the electromagnetic wave propagating direction side becomes shorter. Furthermore, it is good enough to set an opening width w of each power feed window to be larger as a distance between the power feed window and the electromagnetic wave propagating direction side is reduced. Moreover, it is good enough to set each power feed window in such a manner that its central axis parallel with the longitudinal direction of the electromagnetic wave radiation waveguide is offset toward the electromagnetic wave propagating direction side with respect to a central axis of a corresponding electromagnetic wave radiation waveguide as the power feed window is distanced from the electromagnetic wave propagating direction side.

An amount of offset of the central axis of the inductive wall parallel with the longitudinal direction of the electromagnetic wave radiation waveguide toward the electromagnetic wave propagating direction side with respect to the central axis of the corresponding power feed window parallel with the longitudinal direction of the electromagnetic wave radiation waveguide will be referred to as an offset amount S₃ of the inductive wall hereinafter. Additionally, an amount of offset of the central axis of the power feed window parallel with the longitudinal direction of the electromagnetic wave radiation waveguide toward the electromagnetic wave propagating direction with respect to the central axis of the corresponding electromagnetic wave radiation waveguide will be referred to as an offset amount S₂ of the power feed window hereinafter.

In general, a supply quantity of the electromagnetic wave is readily reduced as the electromagnetic wave radiation waveguide is distanced from the electromagnetic wave source. On the contrary, when the opening width w of each power feed window is set to be larger as a distance of the power feed window from the electromagnetic wave propagating direction side is reduced, the electromagnetic wave can be uniformly supplied to each electromagnetic wave radiation waveguide.

Further, when the offset amount (a shift amount) S₂ of each power feed window is set larger as a distance of the power feed window from the electromagnetic wave propagating direction side is increased, a phase shift of the electromagnetic wave can be corrected. Therefore, the electromagnetic wave radiation waveguides adjacent to each other can be excellently coupled with each other with a phase shift of 180 degrees.

Furthermore, when the bulge length h of each inductive wall and the offset amount (the shift amount) S₃ of each inductive wall are adjusted, a reflection wave controlled to have a desired amplitude and phase can be generated in the inductive wall. As a result, a reflection wave generated by provision of each power feed window can be canceled out.

In case a where the opening width w of each power window is set larger as a distance of the power feed window from the electromagnetic wave propagating direction side is reduced and the offset amount S₂ of each power feed window is set larger as a distance of the power feed window from the electromagnetic wave propagating direction side is increased, the bulge length h o each inductive wall is set longer as a distance of the inductive wall from the electromagnetic wave propagating direction side is reduced, and the offset amount S₃ of each inductive wall is set larger as a distance of the inductive wall from the electromagnetic wave propagating direction side is reduced. As a result, it is possible to generate in the inductive wall a reflection wave controlled to cancel out a reflection wave produced by provision of each power feed window.

[13] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave reflection waveguide provided to branch from this electromagnetic wave distribution waveguide; a plurality of slots which are aligned and arranged in each electromagnetic wave radiation waveguide along an electromagnetic wave propagating direction and constitute a waveguide antenna; a plurality of electromagnetic wave radiation windows which are provided to face these slots and formed of a dielectric material; and a processing chamber into which the electromagnetic wave radiated from the slots enters through the electromagnetic wave radiation windows, the plasma processing apparatus generating plasma by using the electromagnetic wave which has entered the processing chamber, thereby performing plasma processing based on this plasma, wherein each electromagnetic wave radiation window is provided to correspond to two or more electromagnetic wave radiation waveguides, and sealing means for holding a vacuum of the processing chamber is provided between each electromagnetic wave radiation window and the processing chamber.

According to this plasma processing apparatus, the plurality of electromagnetic wave radiation waveguides are configured to branch from the electromagnetic wave distribution waveguide through which the electromagnetic wave output from the electromagnetic wave source is propagated. Furthermore, the plurality of slots constituting a waveguide antenna are aligned and arranged in each electromagnetic wave radiation waveguide along the electromagnetic wave propagating direction. Therefore, a substrate to be processed can be uniformly plasma-processed irrespective of a size or a shape of this substrate to be processed to which plasma processing is performed. Moreover, it is possible to obtain a compact plasma processing apparatus having a small apparatus footprint and a low apparatus height.

Additionally, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Further, the electromagnetic wave can be supplied to the plurality of electromagnetic wave radiation waveguides from one electromagnetic wave source through the electromagnetic wave distribution waveguide. Therefore, since the electromagnetic wave having the same frequency can be supplied to the respective electromagnetic wave radiation waveguides, a waveguide antenna capable of radiating the uniform electromagnetic wave can be readily designed.

Furthermore, a force having a gas pressure difference between a substantially atmospheric pressure and a pressure substantially close to a vacuum, i.e., approximately 1 kg/cm² (9.80665×10⁴ Pa) is applied to the electromagnetic wave radiation windows included in the plasma processing apparatus. Therefore, a thickness t₁ of each electromagnetic wave radiation window must be set to a thickness which can withstand this force. In this plasma processing apparatus, each electromagnetic wave radiation window is provided to correspond to two or more electromagnetic wave radiation waveguides, and sealing means for holding a vacuum of the processing chamber is provided between each electromagnetic wave radiation window and the processing chamber. Therefore, the thickness t₁ of each electromagnetic wave radiation window can be reduced as compared with a case where one electromagnetic wave radiation window is provided to correspond to all the electromagnetic wave radiation waveguides. Furthermore, the number of beams which support the electromagnetic wave radiation windows can be reduced as compared with a case where one electromagnetic wave radiation window is provided to correspond to one electromagnetic wave radiation waveguide, thereby improving efficiency of radiating the electromagnetic wave into the processing chamber. Therefore, plasma can be uniformly generated in the processing chamber.

[14] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides provided to branch from this electromagnetic wave distribution waveguide; a slot plate in which a plurality of slots constituting a waveguide antenna are formed and which defines a part of each electromagnetic wave radiation waveguide; an electromagnetic wave radiation window provided to face these slots and formed of a dielectric material; and a processing chamber into which the electromagnetic wave radiated from the slots enters through the electromagnetic wave radiation window, the plasma processing apparatus generating plasma by using the electromagnetic wave which has entered the processing chamber, thereby effecting plasma processing based on this plasma, wherein the plurality of slots are cyclically arranged to correspond to an entire region in which the electromagnetic wave radiation window is arranged.

It is to be noted that “an entire region in which the electromagnetic wave radiation window is arranged” described herein means a region corresponding to one electromagnetic wave radiation window when this electromagnetic wave radiation window alone is provided, and means a region surrounded by a minimum rectangle including all electromagnetic wave radiation windows when the plurality of electromagnetic wave radiation windows are provided.

According to this plasma processing apparatus, the plurality of electromagnetic wave radiation waveguides are configured to branch from the electromagnetic wave distribution waveguide through which the electromagnetic wave output from the electromagnetic wave source is propagated. Furthermore, this plasma processing apparatus is provided with the slot plate which defines a part of each electromagnetic wave radiation waveguide. The plurality of slots constituting the waveguide antenna are provided to the slot plate. In the plasma processing apparatus having such a configuration, a substrate to be processed can be uniformly plasma-processed irrespective of a size or a shape of this substrate to be processed to which the plasma processing is performed. Moreover, it is possible to obtain a compact plasma processing apparatus having a small apparatus footprint and a low apparatus height.

Additionally, since each waveguide does not have a central conductor which can be a factor of a propagation loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Further, the electromagnetic wave can be supplied to the plurality of electromagnetic wave radiation waveguides from one electromagnetic wave source through the electromagnetic wave distribution waveguide. Therefore, the electromagnetic wave having the same frequency can be supplied to the respective electromagnetic wave radiation waveguides, whereby a waveguide antenna capable of radiating the uniform electromagnetic wave can be easily designed.

Furthermore, in this plasma processing apparatus, since the plurality of slots are cyclically arranged to correspond the entire region in which the electromagnetic wave radiation window is arranged, the electromagnetic wave is allowed to uniformly enter the processing chamber. Therefore, plasma can be further uniformly generated in the processing chamber.

[15] The plasma processing apparatus according to the present invention comprises: an electromagnetic wave source which outputs an electromagnetic wave; an electromagnetic wave distribution waveguide through which the electromagnetic wave output from this electromagnetic wave source is propagated; a plurality of electromagnetic wave radiation waveguides provided to branch from this electromagnetic wave distribution waveguide; a plurality of slots which are provided to each of these electromagnetic wave radiation waveguides and constitute a waveguide antenna; and a processing chamber into which the electromagnetic wave radiated from the slots enters, the plasma processing apparatus generating plasma by using the electromagnetic wave which has entered the processing chamber from the slots, thereby effecting plasma processing based on this plasma, wherein a choke is provided to correspond to the electromagnetic wave distribution waveguide and at least one of the plurality of electromagnetic wave radiation waveguides.

According to this plasma processing apparatus, the plurality of electromagnetic wave radiation waveguides are configured to branch from the electromagnetic wave distribution waveguide through which the electromagnetic wave output from the electromagnetic wave source is propagated. Moreover, the plurality of slots constituting the waveguide antenna are provided to each of the electromagnetic wave radiation waveguides. Therefore, a substrate to be processed can be uniformly plasma-processed irrespective of a size or a shape of this substrate to be processed to which the plasma processing is performed. Additionally, it is possible to obtain a compact plasma processing apparatus having a small apparatus footprint and a low apparatus height.

Further, since each waveguide does not have a central conductor which can be a factor of a transmission loss of the electromagnetic wave as different from a coaxial tube, the electromagnetic wave can be propagated with a small propagation loss of the electromagnetic wave and large power. Therefore, even the plasma processing apparatus which propagates the electromagnetic wave with large power can be readily designed.

Furthermore, the electromagnetic wave can be supplied to the plurality of electromagnetic wave radiation waveguides from one electromagnetic wave source through the electromagnetic wave distribution waveguide. Therefore, since the electromagnetic wave having the same frequency can be supplied to the respective electromagnetic wave radiation waveguides, a waveguide antenna capable of radiating the uniform electromagnetic wave can be easily designed.

Moreover, in this plasma processing apparatus, the choke is provided to correspond to the electromagnetic wave distribution waveguide and at least one of the plurality of electromagnetic wave radiation waveguides. Therefore, it is possible to suppress the electromagnetic wave from leaking from a joint surface or the like produced when constituting the waveguides. Accordingly, a processing accuracy or a joining method when constituting the waveguides can be facilitated.

It is to be noted that, as the electromagnetic wave distribution waveguide and each electromagnetic wave radiation waveguide included in the plasma processing apparatus described in each of [1] to [15], a rectangular waveguide can be preferably used. Additionally, both the electromagnetic wave distribution waveguide and each electromagnetic wave radiation waveguide included in the plasma processing apparatus described in each of [1] to [14] may be hollow, i.e., filled with air, or may be filled with a dielectric member. Therefore, “the dielectric material in the electromagnetic wave distribution waveguide” and “the dielectric material in the electromagnetic wave radiation waveguide” include air.

As “the dielectric material in the electromagnetic wave distribution waveguide” and “the dielectric material in the electromagnetic wave radiation waveguide”, it is preferable to select a material having a small loss of the electromagnetic wave. The loss of the electromagnetic wave is determined by a product of a dielectric constant of the dielectric material and a dielectric loss angle (a dielectric tangent tan δ), and the loss of the magnetic wave is reduced as the product becomes smaller. Therefore, as “the dielectric material in the electromagnetic wave distribution waveguide” and “the dielectric material in the electromagnetic wave radiation waveguide”, it is preferable to use a dielectric material having a small product of the dielectric constant and the dielectric loss angle, e.g., quartz (synthetic quartz) or a fluorocarbon resin. Further, alumina has a slightly large product of the dielectric constant and the dielectric loss angle, large mechanical strength and a low price as compared with quartz, a fluorocarbon resin or the like. Therefore, alumina is preferable as “the dielectric material in the electromagnetic wave distribution waveguide” and “the dielectric material in the electromagnetic wave radiation waveguide”.

As the plasma processing apparatus described in each of [1] to [6], [9] to [12] and [15], it is possible to design both the apparatus in which the electromagnetic wave radiation waveguides are provided outside the processing chamber and the electromagnetic wave radiation window is provided to the processing chamber to allow the electromagnetic wave radiated from the slots to enter the processing chamber through the electromagnetic wave radiation window, and the apparatus in which the electromagnetic wave radiation waveguides are provided in the processing chamber to allow the electromagnetic wave radiated from the slots to directly enter the processing chamber, for example.

Furthermore, the plasma processing apparatus in each of [7], [8], [13] and [14] can be designed like the former apparatus mentioned above.

In case of the above-described former apparatus, the electromagnetic wave radiation window can be provided as a part of a wall of the processing chamber when the electromagnetic wave radiation window is supported by, e.g., a beam formed of an electroconductive member. In this case, however, the beam formed of the electroconductive member is provided in the vicinity of an inner surface of the electromagnetic wave radiation window which serves as an incidence surface when the electromagnetic wave enters the processing chamber, and hence plasma hardly spreads in the processing chamber.

On the other hand, in case of the latter apparatus mentioned above, the plurality of slots must be provided to each electromagnetic wave radiation waveguide in a state where these slots are opened in the processing chamber, but this can be relatively easily realized by forming the slots in a slot plate which also functions as a part of a wall of each electromagnetic wave radiation waveguide. In this case, however, a part in the vicinity of an outlet of each slot is formed of a conductor, and hence plasma hardly spreads in the processing chamber.

Therefore, when designing a plasma processing apparatus like the former apparatus is desired, it is preferable to cover the beam with a covering dielectric member from the inside of the processing chamber like the plasma processing apparatus described in claim 17 according to the present invention. Moreover, in this case, the electromagnetic wave radiation window as well as the beam may be covered with the covering dielectric member from the inside of the processing chamber. When this configuration is adopted, plasma can excellently spread in the processing chamber, and a surface wave can be propagated. It is to be noted that the covering dielectric member may be integrally formed or separately formed.

Additionally, when designing a plasma processing apparatus like the latter apparatus is desired, it is preferable to provide in the processing chamber a covering dielectric member which covers the plurality of slots from the inside of the processing chamber like the plasma processing apparatus described in claim 16 according to the present invention. According to this configuration, plasma can be excellently diffused in the processing chamber. It is to be noted that the covering dielectric member may be integrally formed or separately formed.

Further, when the covering dielectric member is provided in the processing chamber to cover the plurality of slots, surface wave plasma can be generated in the processing chamber. That is, when a predetermined process gas is led into the processing chamber and the electromagnetic wave is allowed to enter this processing chamber, the process gas is excited to generate plasma, and an electron density in the plasma is increased in the vicinity of a region where the electromagnetic wave has entered (in the vicinity of an outlet of each slot). When the electron density in plasma is increased in the vicinity of the region where the electromagnetic wave has entered, the electromagnetic wave is hardly propagated in plasma and attenuated in this plasma. Therefore, the electromagnetic wave does not reach a region apart from the vicinity of the region where the electromagnetic wave has entered, and hence the region in which the process gas is excited by the electromagnetic wave is restricted to the vicinity of the region where the electromagnetic wave has entered. As a result, surface wave plasma is generated.

In plasma processing using the surface wave plasma, it is possible to suppress an ion from damaging a substrate to be processed. That is, in a state where the surface wave plasma is generated, a region in which an energy produced by the electromagnetic wave is given to cause ionization of a process gas or the like locally exists in the vicinity of the region where the electromagnetic wave has entered. Therefore, when the substrate to be processed is provided at a position apart from the region where the electromagnetic wave has entered by a predetermined distance, an electron temperature in the vicinity of a processing target surface of the substrate to be processed can be maintained low. That is, since an increase in electric field of a sheath generated in the vicinity of the processing target surface of the substrate to be processed can be suppressed, an incidence energy of the ion with respect to the substrate to be processed is reduced, thereby suppressing the ion from damaging the substrate to be processed.

Therefore, when the covering dielectric member is provided to cover the plurality of slots from the inside of the processing chamber, it is possible to obtain a plasma processing apparatus which can suppress an ion damage which is given to a substrate to be processed subjected to plasma processing.

In case of carrying out the plasma processing apparatus in each of [1] to [17] mentioned above, it is possible to preferably use an apparatus which supplies an electromagnetic wave having a frequency of 13.56 MHz, 27.12 MHz, 40.68 MHz, 915 MHz, 2.45 GHz, 5.8 GHz or 24.125 GHz as an industrial frequency band (an ISM frequency band). According to this configuration, an influence on a communication frequency can be reduced, shielding or the like of a leak electromagnetic wave can be readily performed.

When supply of a microwave as the electromagnetic wave into the processing chamber is desired, it is preferable to use an electromagnetic wave source having a frequency of 2.45 GHz like the plasma processing apparatus described in claim 18 according to the present invention. As the frequency of the electromagnetic wave source, 2.45 GHz is currently a standard. Therefore, such an electromagnetic wave source is inexpensive, and a wide variety of such electromagnetic wave sources exist. Moreover, when a frequency range is set to 2.45 GHz±50 MHz, an industrial frequency band is provided, and an influence on a communication frequency band can be reduced, thereby facilitating shielding or the like of a leak electromagnetic wave of the apparatus. Therefore, when the electromagnetic wave source having a frequency of 2.45 GHz is adopted, a microwave as the electromagnetic wave can be supplied into the processing chamber.

In case of carrying out the plasma processing apparatus in each of [1] to [18], it is preferable for the plurality of slots provided to each electromagnetic wave radiation waveguide to be alternately arranged on a pair of virtual lines parallel with each other like the plasma processing apparatus in [19]. According to this configuration, the electromagnetic wave led through the electromagnetic wave radiation waveguides can be excellently discharged into the processing chamber from the plurality of slots provided to each of the electromagnetic wave radiation waveguides.

The plasma processing apparatus 1 and the plasma processing method according to the present invention are not restricted to the above-described embodiments, and can be carried out in many ways without departing from the scope of the invention.

What is claimed is:

1. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides which branch from either an electric field surface or a magnetic field surface of the electromagnetic wave distribution waveguide in a vertical direction, and are closely aligned and provided in parallel;
a plurality of slots which are provided to each of the electromagnetic wave radiation waveguides and constitute a waveguide antenna; and
a processing chamber into which the electromagnetic wave radiated from the slots enters, wherein, when a guide wavelength λ_{g1} of the electromagnetic wave output from the electromagnetic wave source in the electromagnetic wave distribution waveguide is represented by the following expression:
λ_{g1}=λ₀/{square root over (εr1−(λ₀/(2a₁))²)}
a width a₂ in the electromagnetic wave radiation waveguide, a height b₂ in the electromagnetic wave radiation waveguide and a cycle p in which the electromagnetic wave radiation waveguides are aligned are set to satisfy the following relationship:
λ₀>p>a₂>b₂
where λ₀ is a free space wavelength of the electromagnetic wave output from the electromagnetic wave source, a₁ is a width in the electromagnetic wave distribution waveguide, and εᵣ₁ is a specific inductive capacity of a dielectric material in the electromagnetic wave distribution waveguide, and the plasma is generated by the electromagnetic wave which has entered the processing chamber from the slots.

2. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
an electromagnetic wave radiation waveguides which branch from an electric field or a magnetic field of the electromagnetic wave distribution waveguide in a vertical direction, and are closely aligned and provided in parallel;
a plurality of slots which are provided to each of the electromagnetic wave radiation waveguides and constitute a waveguide antenna; and
a processing chamber into which the electromagnetic wave radiated from the slots enters,
wherein, when a guide wavelength λ_{g1} of the electromagnetic wave output from the electromagnetic wave source in the electromagnetic wave distribution waveguide is represented by the following expression:
λ_{g1}=λ₀/{square root over (εᵣ₁−(λ₀/(2a₁))²)}
a width a2ₘ (m=an integer from 1 to n) in the electromagnetic wave radiation waveguide, a height b₂ in the electromagnetic wave radiation waveguide and a cycle pₘ (m=an integer from 1 to n) in which the electromagnetic wave radiation waveguides are aligned are set to satisfy the following relationship:
λ₀>pₘ>a²m>b₂ (m=an integer from 1 to n)
and
pₘ=(λ_{g1}/2)±α (where α is 5% or below of λ_{g1})
where λ₀ is a free space wavelength of the electromagnetic wave output from the electromagnetic wave source, a₁ is a width in the electromagnetic wave distribution waveguide, and εᵣ₁ is a specific inductive capacity of a dielectric material in the electromagnetic wave distribution waveguide, and
the plasma is generated by the electromagnetic wave which has entered the processing chamber from the slots.

3. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides which are provided to branch from the electromagnetic wave distribution waveguide;
a plurality of slots which are aligned and arranged in each electromagnetic wave radiation waveguide along an electromagnetic wave propagating direction, and constitute a waveguide antenna; and
a processing chamber into which the electromagnetic wave radiated from the slots enter,
wherein a gap d between the slots which are adjacent to each other along the electromagnetic wave propagating direction is set to satisfy the following relationship:
λ₀>d
where λ₀ is a free space wavelength of the electromagnetic wave output from the electromagnetic wave source, and
the plasma is generated by the electromagnetic wave which has entered the processing chamber from the slots.

4. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides which branch from an electric field surface or a magnetic field surface of the electromagnetic wave distribution waveguide in a vertical direction, and are closely aligned and provided in parallel;
a plurality of slots which are aligned and arranged in each electromagnetic wave radiation waveguide along an electromagnetic wave propagating direction, and constitute a waveguide antenna; and
a processing chamber into which the electromagnetic wave radiated from the slots enters,
wherein, when a guide wavelength λ_{g1} of the electromagnetic wave output from the electromagnetic wave source in the electromagnetic wave distribution waveguide is represented by the following expression:
λ_{g1}=λ₀/{square root over (εᵣ₁−(λ₀/(2a₁))²)}
a width a₁ in the electromagnetic wave radiation waveguide, a height b₂ in the electromagnetic wave radiation waveguide and a cycle p in which the electromagnetic wave radiation waveguides are aligned are set to satisfy the following relationship:
λ₀>p>a₂>b₂
and
p=(λ_{g1}/2)±α (where α is 5% or below of λ_{g1})
where λ₀ is a free space wavelength of the electromagnetic wave output from the electromagnetic wave source, a₁ is a width in the electromagnetic wave distribution waveguide, and εᵣ₁ is a specific inductive capacity of a dielectric material in the electromagnetic wave distribution waveguide, and
a gap d between the slots which are adjacent to each other along the electromagnetic wave propagating direction is set to satisfy the following relationship:
λ₀>d
where λ₀ is a free space wavelength of the electromagnetic wave output from the electromagnetic wave source, and
the plasma is generated by the electromagnetic wave which has entered the processing chamber from the slots.

5. The plasma processing apparatus according to claim 1, wherein an area of a slot provided at the farthest position from the electromagnetic wave distribution waveguide of the plurality of slots provided to each electromagnetic wave radiation waveguide is set larger than areas of any other slots, and
a distance between a central position of the slot provided at the farthest position from the electromagnetic wave distribution waveguide and a trailing end of the electromagnetic wave radiation waveguide to which the slot is provided is set to ¼ of a wavelength of the electromagnetic wave output from the electromagnetic wave source in the electromagnetic wave radiation waveguide.

6. The plasma processing apparatus according to claim 5, wherein the height b₂ of the electromagnetic wave radiation waveguide is set to ½ or below of the width a₂.

7. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides provided to branch from the electromagnetic wave distribution waveguide;
a plurality of slots which are aligned and arranged in each electromagnetic wave radiation waveguide along an electromagnetic wave propagating direction, and constitute a waveguide antenna;
an electromagnetic wave radiation window which is provided to face the slots and formed of a dielectric material; and
a processing chamber into which the electromagnetic wave radiated from the slots enters through the electromagnetic wave radiation window,
wherein a thickness of the electromagnetic wave radiation window is set to an integral multiple of ½ of a wavelength of the electromagnetic wave output from the electromagnetic wave source in the electromagnetic wave radiation window, and the plasma is generated by the electromagnetic wave which has entered the processing chamber.

8. The plasma processing apparatus according to claim 7, wherein a distance between the electromagnetic wave radiation window and the slots facing the electromagnetic wave radiation window is set to ⅛ or above of the free space wavelength λ₀ of the electromagnetic wave output from the electromagnetic wave source.

9. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave is propagated;
a plurality of electromagnetic wave radiation waveguides which branch from an electric field surface or a magnetic field surface of the electromagnetic wave distribution waveguide in a vertical direction, and are closely aligned and provided in parallel;
a plurality of slots which are provided to each of the electromagnetic wave radiation waveguides, and constitute a waveguide antenna; and
a processing chamber into which the electromagnetic wave radiated from the slots enters,
wherein the same amount of power is fed in phase to the respective electromagnetic wave radiation waveguides through Π junction, and
the plasma is generated by the electromagnetic wave which has entered the processing chamber from the slots.

10. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides which branch from an electric field surface or a magnetic field surface of the electromagnetic wave distribution waveguide in a vertical direction, and are closely aligned and provided in parallel;
a plurality of slots which are provided to each of the electromagnetic wave radiation waveguides, and constitute a waveguide antenna; and
a processing chamber into which the electromagnetic wave radiated from the slots enters,
wherein the same amount of power is fed in reversed phases to the electromagnetic wave radiation waveguides adjacent to each other, and
the plasma is generated by the electromagnetic wave which has entered the processing chamber from the slots.

11. The plasma processing apparatus according to claim 10, wherein a cycle p in which the electromagnetic wave radiation waveguides are aligned is set to ½ of a guide wavelength λ_{g1} of the electromagnetic wave output from the electromagnetic wave source in the electromagnetic wave distribution waveguide, a plurality of power feed windows which allow the electromagnetic wave distribution waveguide to communicate with each electromagnetic wave radiation waveguide are respectively provided at coupling parts between the electromagnetic wave distribution waveguide and the respective electromagnetic wave radiation waveguides, and a plurality of inductive walls are provided in the electromagnetic wave distribution waveguide to correspond to the respective electromagnetic wave radiation waveguides, thereby feeding the same amount of power in reversed phases to the electromagnetic wave radiation waveguides which are adjacent to each other.

12. The plasma processing apparatus according to claim 11, wherein the plurality of inductive walls are provided on a surface facing a surface from which the electromagnetic wave radiation waveguides branch to bulge toward the respective corresponding electromagnetic wave radiation waveguides,
each inductive wall arranged closer to the electromagnetic wave propagating direction side is set to have a longer bulge length, and each inductive wall arranged closer to the electromagnetic wave propagating direction side is set to have a central axis parallel with a longitudinal direction of the electromagnetic wave radiation waveguide being offset toward the electromagnetic wave propagating direction side with respect to a central axis of a corresponding power feed window parallel with the longitudinal direction of the electromagnetic wave radiation waveguide, and
each power feed window arranged to be closer to the electromagnetic wave propagating direction side is set to have a larger opening width, and each power feed window arranged away from the electromagnetic wave propagating direction side is set to have a central axis parallel with the longitudinal direction of the electromagnetic wave radiation waveguide being offset toward the electromagnetic wave propagating direction side with respect to a central axis of a corresponding electromagnetic wave radiation waveguide.

13. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides provided to branch from the electromagnetic wave radiation waveguide;
a plurality of slots which are aligned and arranged in each electromagnetic wave radiation waveguide along an electromagnetic wave propagating direction, and constitute a waveguide antenna;
a plurality of electromagnetic wave radiation windows which are provided to face the slots and formed of a dielectric material; and
a processing chamber into which the electromagnetic wave radiated from the slots enters through the electromagnetic wave radiation windows,
wherein each electromagnetic wave radiation window is provided to correspond two or more electromagnetic wave radiation waveguides, and sealing means for holding a vacuum of the processing chamber is provided between each electromagnetic wave radiation window and the processing chamber, and
the plasma is generated by the electromagnetic wave which has entered the processing chamber.

14. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides provided to branch from the electromagnetic wave distribution waveguide;
a slot plate which has a plurality of slots constituting a waveguide antenna formed therein, and defines a part of each electromagnetic wave radiation waveguide;
an electromagnetic wave radiation window which is provided to face the slots and formed of a dielectric material; and
a processing chamber into which the electromagnetic wave radiated from the slots enters through the electromagnetic wave radiation window, wherein the plurality of slots are cyclically arranged to correspond an entire region in which the electromagnetic wave radiation window is arranged, and the plasma is generated by the electromagnetic wave which has entered the processing chamber.

15. A plasma processing apparatus which performs plasma processing with respect to a substrate to be processed, comprising:
an electromagnetic wave source which outputs an electromagnetic wave;
an electromagnetic wave distribution waveguide through which the electromagnetic wave output from the electromagnetic wave source is propagated;
a plurality of electromagnetic wave radiation waveguides provided to branch from the electromagnetic wave distribution waveguide;
a plurality of slots which are provided to each of the electromagnetic wave radiation waveguides and constitute a waveguide antenna; and
a processing chamber into which the electromagnetic wave radiated from the slots enters,
wherein a choke is provided to correspond to the electromagnetic wave distribution waveguide and at least one of the plurality of electromagnetic wave radiation waveguides, and
the plasma is generated by the electromagnetic wave which has entered the processing chamber from the slots.

16. The plasma processing apparatus according to claim 1, wherein the slots are opened in the processing chamber, and
a covering dielectric member which covers the plurality of slots from the inside of the processing chamber is provided in the processing chamber.

17. The plasma processing apparatus according to claim 7, wherein the electromagnetic wave radiation window is supported by a beam formed of a conductor, and the beam is covered with a covering dielectric member from the inside of the processing chamber.

18. The plasma processing apparatus according to claim 1, wherein a frequency of the electromagnetic wave source is 2.45 GHz.

19. The plasma processing apparatus according to claim 1, wherein the plurality of slots provided in each electromagnetic wave radiation waveguide are alternately arranged on a pair of parallel virtual lines.
